(19) United States
(12) Patent Application Publication
(10) Pub. No.: US 2014/0012553 A1
(43) Pub. Date: Jan. 9, 2014

(54) SYSTEMS AND METHODS FOR AGGREGATING AND EVALUATING ENVIRONMENTAL DATA

(71) Applicant: United Parcel Service of America, Inc., (US)

(72) Inventors: Nguashima Kelly, Tucker, GA (US); Jared Barriere, East Orange, NJ (US); Charles Stazo, Monroe, NY (US); Timothy Eisentraut, Middletown, NY (US); Madelaine R. Galati, Denville, NJ (US); Diana Orellano, Hackensack, NJ (US); Mona Patel, Maywood, NJ (US)

(73) Assignee: United Parcel Service of America, Inc., Atlanta, GA (US)

(21) Appl. No.: 13/840,501

(22) Filed: Mar. 15, 2013

Related U.S. Application Data
(60) Provisional application No. 61/636,343, filed on Apr. 20, 2012.

(51) Int. Cl. G06F 17/50

(52) U.S. Cl. CPC G06F 17/5009
USPC 703/6

(57) ABSTRACT

Various embodiments of the present invention are directed to an environmental impact analysis system configured for providing a graphical user interface for displaying a plurality of user consumption inquiries soliciting user input relating to user consumption of one or more resources; receiving user input comprising user consumption data responsive to one or more of the user consumption inquiries; displaying one or more impact reduction goals representing potential user actions that would result in a lesser environmental footprint; and receiving user input comprising goal completion data indicating user completion of one or more of the impact reduction goals. Various embodiments of the system are further configured to determine user impact values indicative of the environmental footprint resulting from user consumption of the one or more resources, and to determine revised user impact values indicative of the user's reduced environmental footprint due to completed impact reduction goals.

### CROSS-REFERENCE TO RELATED APPLICATIONS

This application claims the benefit of U.S. Provisional Application No. 61/636,343, filed Apr. 20, 2012, the entirety of which is hereby incorporated by reference

### BACKGROUND OF THE INVENTION

1. Field of the Invention

Various embodiments of the present invention described herein generally relate to systems and methods for aggregating and evaluating environmental data.

2. Description of Related Art

As awareness of environmental issues has grown, public and private organizations have become increasingly concerned with their collective impact on the environment. Many organizations (e.g., large corporations or government entities) are now interested in building awareness of environmental issues among employees and incentivizing those employees to adopt environmentally responsible habits both inside and outside the work place. As a result, there is an on-going need in the art for systems and methods for evaluating environmental aspects of individual behavior and communicating that information in an efficient and effective manner.

### BRIEF SUMMARY OF THE INVENTION

Various embodiments of the present invention are generally directed to an environmental impact analysis system for analyzing the environmental impact of one or more system users. According to various embodiments, the system comprises one or more memory storage areas and one or more processors. In various embodiments, the one or more processors are configured to: display via a user interface a plurality of user consumption inquiries soliciting user input relating to user consumption of one or more resources; receive via the user interface user input comprising user consumption data responsive to one or more of the user consumption inquiries; calculate, based on the user consumption data, one or more user impact values indicative of the environmental footprint resulting from the user consumption of the one or more resources; display via the user interface one or more of the calculated user impact values; display via the user interface one or more impact reduction goals representing potential user actions that would result in a lesser environmental footprint; receive via the user interface user input comprising goal completion data indicating user completion of one or more of the impact reduction goals; and calculate, based on the user impact values and the goal completion data, one or more revised user impact values indicative of the user's reduced environmental footprint due to completed impact reduction goals.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates a block diagram of an environmental impact analysis system according to one embodiment of the present invention;

FIG. 2 illustrates a block diagram of a central server according to one embodiment of the present invention;

FIG. 3 illustrates a home page of a graphical user interface according to one embodiment of the present invention;

FIG. 4 illustrates a flow diagram of steps executed by user registration module according to one embodiment of the present invention;

FIG. 5 illustrates a flow diagram of steps executed by a data capture module according to one embodiment of the present invention;

FIG. 6 illustrates a travel user consumption inquiry page of a graphical user interface according to one embodiment of the present invention;

FIG. 7 illustrates a flow diagram of steps executed by a user incentive module according to one embodiment of the present invention;

FIG. 8 illustrates a recycling impact reduction goal page of a graphical user interface according to one embodiment of the present invention;

FIG. 9 illustrates a flow diagram of steps executed by a user impact module according to one embodiment of the present invention; and

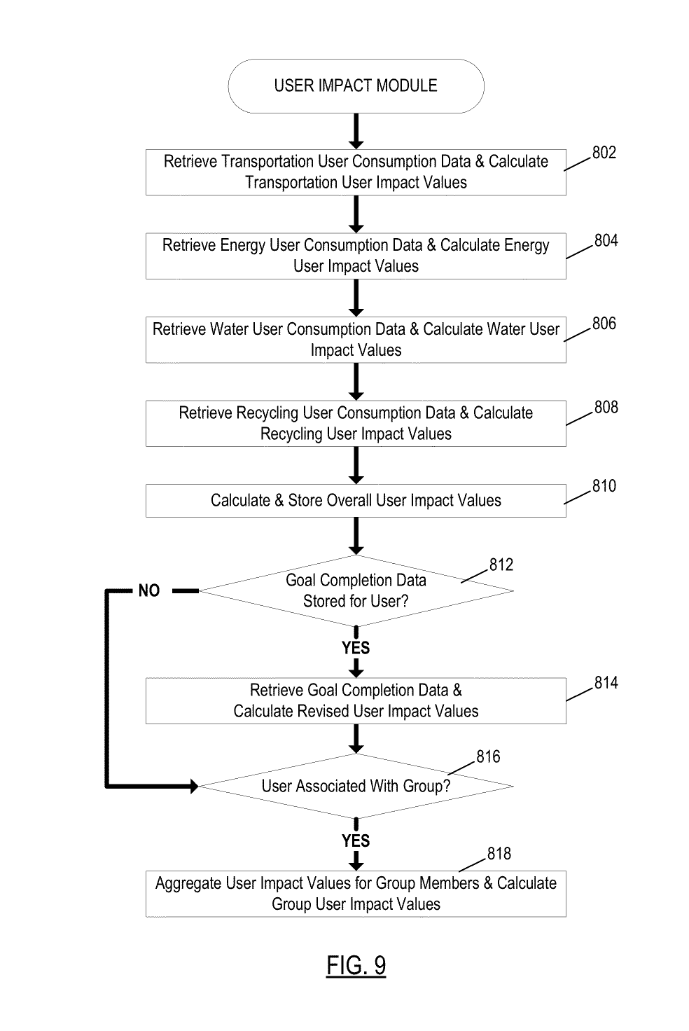

FIG. 10 illustrates a user footprint page and group footprint page of a graphical user interface according to one embodiment of the present invention.

### DETAILED DESCRIPTION OF THE INVENTION

Embodiments of the present invention now will be described more fully hereinafter with reference to the accompanying drawings, in which some, but not all embodiments of the invention is shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview

Various embodiments of the present invention described herein are directed to systems and methods for soliciting and receiving environmental data from one or more system users (e.g., employees), aggregating the received environmental data, and evaluating the environmental data to determine various statistics indicative of the environmental footprint of one or more users. In particular, various embodiments of the systems and methods are configured to provide analytical, communication, and networking tools for engaging users and assisting them in relating everyday actions to greater environmental results.

As described in the greater detail herein, various embodiments of the present invention contemplate an environmental impact analysis system configured for providing a user interface (e.g., an online graphical user interface) that enables users (e.g., employees) to provide information indicative of their own environmentally impactful behavior in response to questions presented via the interface. The system is further configured to evaluate this data to determine various environmental statistics for a particular user (e.g., the total carbon footprint for a particular user, the carbon footprint attributable to a particular user's transportation activities). The system is also configured to determine environmental statistics and provide various analytical tools for aggregated groups of users (e.g., determining the total carbon footprint of a user's household, determining the total carbon footprint of employees in a particular department of a corporation, determining the average carbon footprint of all employees). As a result, the system is able to provide users with details about their resource consumption levels (e.g., consumption of fuel, energy, water, and other resources) and help them understand how this consumption impacts the environment (e.g., via CO₂ emissions).

In addition, various embodiments of the environmental impact analysis system are configured to present users with various goals for improving the environmental sustainability of their behavior in key areas (e.g., energy, fuel, waste, and water), indicate how achievement of these goals may alter the environmental impact of a user or group of users, and update environmental impact data upon achievement of one or more of the goals by one or more users. The system also enables users to network with other users of the system to challenge one another to accomplish various goals. In this way, the system is able to incentivize environmentally sustainable behavior and generate awareness of environmental impact across a broad range of system users.

As will be appreciated from the description herein, the embodiments of the present invention may be implemented in various ways, including as methods, apparatuses, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium (e.g., a non-transitory computer readable medium). Any suitable computer-readable storage medium may be utilized including hard disks, CD-ROMs, optical storage devices, or magnetic storage devices.

### Environmental Impact Analysis System

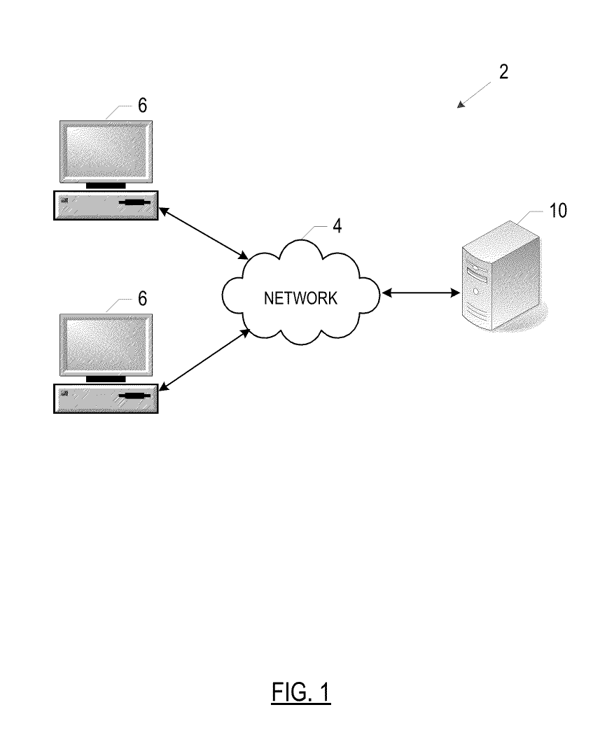

An environmental impact analysis system 2 according to one embodiment is shown in FIG. 1. In the illustrated embodiment, the environmental impact analysis system 2 comprises one or more user computers 6 configured to communicate with a central server 10 over a network 4. As explained in detail herein, the central server 10 is generally configured for providing a graphical user interface accessible over the network 4 by the user computers 6. Via the user interface, the central server 10 is generally configured to display a plurality of user consumption inquiries soliciting user input relating to user consumption of one or more resources; receive user input comprising user consumption data responsive to one or more of the user consumption inquiries; display one or more impact reduction goals representing potential user actions that would result in a lesser environmental footprint; and receive user input comprising goal completion data indicating user completion of one or more of the impact reduction goals. In addition, the central server 10 is configured to calculate, based on the user consumption data, user impact values indicative of the environmental footprint resulting from the user consumption of the one or more resources, and calculate, based on the user impact values and the goal completion data, revised user impact values indicative of the user's reduced environmental footprint due to completed impact reduction goals.

In various embodiments, the one or more user computers 6 may be desktop computers, laptop computers, tablet computers, smart phones, or other computing devices capable of communicating with the central server 10 over the network 4. According to various embodiments, the network 4 may comprise the Internet, an Intranet, or other suitable communication network. For example, in certain embodiments the network 4 may be capable of supporting communication in accordance with any one or more of a number of second-generation (2G), 2.5G and/or third-generation (3G ) mobile communication protocols or the like. Additionally, the user computers 6 and central server 10 may be configured to communicate with one another in accordance with other techniques such as, for example, radio frequency (RF), Bluetooth™, infrared (IrDA), or any of a number of different wireless networking techniques, including Wireless LAN (WLAN) techniques.

### Central Server

In various embodiments, the central server 10 includes various means for performing one or more functions in accordance with embodiments of the present invention, including those more particularly shown and described herein. It should be understood, however, that the central server may include alternative devices for performing one or more like functions, without departing from the spirit and scope of the present invention.

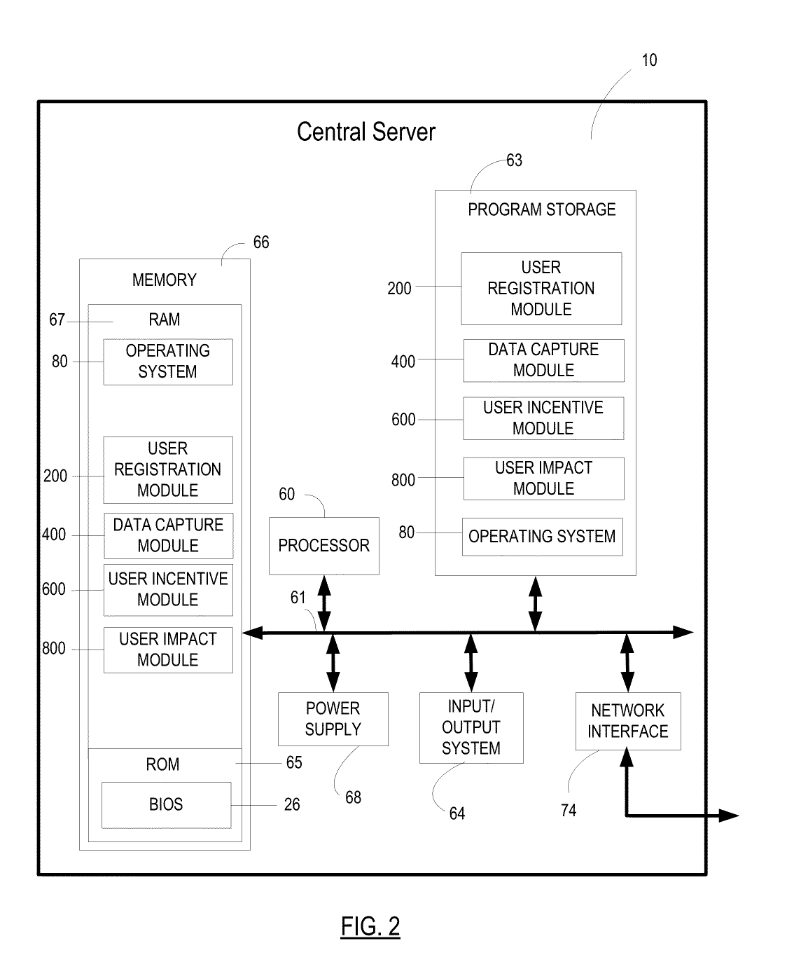

FIG. 2 is a schematic diagram of the central server 10 according to various embodiments. The central server 10 includes a processor 60 that communicates with other elements within the central server 10 via a system interface or bus 61. Also included in the central server 10 is a display device/input device 64 for receiving and displaying data. This display device/input device 64 may be, for example, a keyboard or pointing device that is used in combination with a monitor. The central server 10 further includes memory storage areas 66, which preferably include both read only memory (ROM) 65 and random access memory (RAM) 67. The server's ROM 65 is used to store a basic input/output system 26 (BIOS), containing the basic routines that help to transfer information between elements within the central server 10.

In addition, the central server 10 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage. It is important to note that the computer-readable media described above could be replaced by any other type of computer-readable media known in the art.

A number of program modules may be stored by the various storage devices and within RAM 67. Such program modules include an operating system 80, a user registration module 200, a data capture module 400, a user incentive module 600, and a user impact module 800. According to various embodiments, the user registration module 200, data capture module 400, user incentive module 600, and user impact module 800 control certain aspects of the operation of the central server 10 with the assistance of the processor 60 and operating system 80.

In a particular embodiment, these program modules 200, 400, 600, and 800, are executed by the central server 10 and are configured to generate graphical user interfaces accessible to users of the system. As noted in regard to the embodiment of FIG. 1, the user interfaces may be accessible via the user computers 6 over the network 4. In other embodiments, one or more of the modules 200, 400, 600, and 800 may be stored locally on one or more computers and executed by one or more processors of the computers. According to various embodiments, the modules 200, 400, 600, and 800 may send data to, receive data from, and utilize data contained in, a database, which may be comprised of one or more separate, linked databases and may be housed within or remotely from the central server 10.

Also located within the central server 10 is a network interface 74, for interfacing and communicating with other elements of a computer network. It will be appreciated by one of ordinary skill in the art that one or more of the central server 10 components may be located geographically remotely from other central server 10 components. Furthermore, one or more of the components may be combined, and additional components performing functions described herein may be included in the central server 10.

While the foregoing describes a single processor 60, as one of ordinary skill in the art will recognize, the central server 10 may comprise multiple processors operating in conjunction with one another to perform the functionality described herein. In addition to the memory 66, the processor 60 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface. The user input interface, in turn, can comprise any of a number of devices allowing the entity to receive data from a user, such as a keypad, a touch display, a joystick or other input device.

While reference is made to a central “server” 10, as one of ordinary skill in the art will recognize, embodiments of the present invention are not limited to a client-server architecture. The system of embodiments of the present invention is further not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), or similar electronic devices, collaborating with one another to provide the functionality described herein in association with the central server 10 may likewise be used without departing from the spirit and scope of embodiments of the present invention.

### Environmental Impact Analysis User Interface

According to various embodiments, the central server 10 is configured for generating a graphical user interface in order to solicit user input relating to user consumption of one or more resources (e.g., fuel, energy, water, etc.). Based on this user input, the central server 10 is further configured to calculate various user impact values indicative of one or more user's environmental footprint (e.g., pounds of CO2 emitted, gallons of water used, etc.). These user impact values are then communicated to a user via the graphical user interface in order provide information about the user's consumption and environmental footprint.

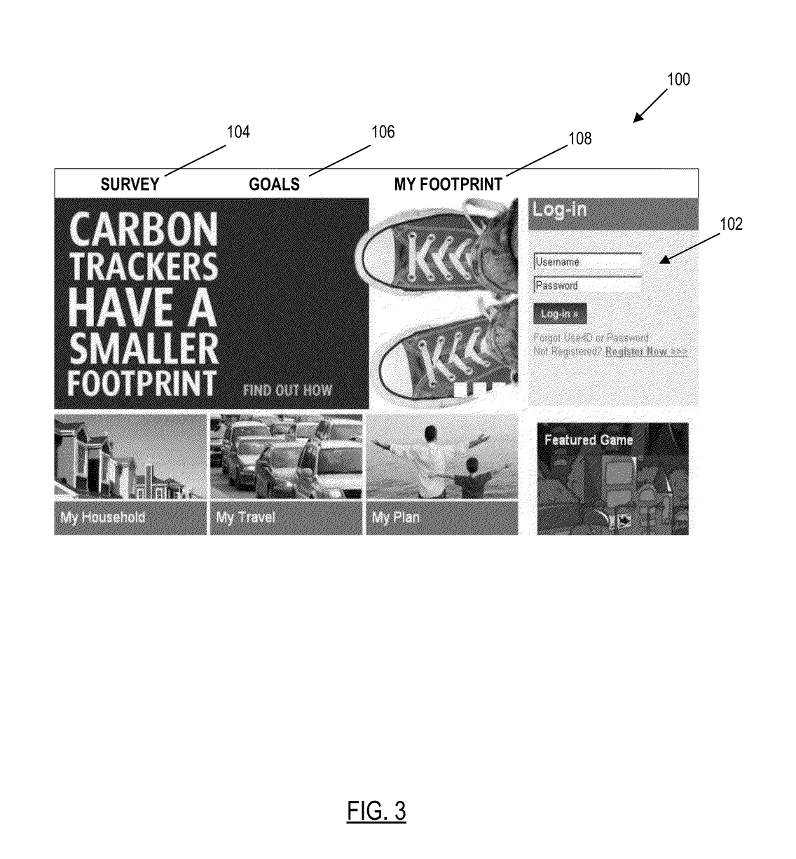

In order to enable users to navigate among the various functionalities provided by the central server 10, the graphical user interface includes a home page 100. As shown in FIG. 3, the home page includes a log-in field 102, survey link 104, goals link 106, and footprint link 108. In response to user selection of the various fields and links 102-108, the central server 10 is configured to execute the various program modules 200, 400, 600, 800 in order to provide the various system functionalities. The steps executed by these various modules will now be described in greater detail.

### User Registration Module

According to various embodiments, the user registration module 200 is generally configured for soliciting and capturing user profile information. In various embodiments, the user profile information is used for associating received user consumption data with a particular user, and for relating various users as members of one or more user groups (e.g., household, employees of a common company, employees in common work division or unit). Accordingly, in response to user selection of, or input into, the log-in field 102 of the user interface home page, the central server 10 is configured to execute the user registration module 200.

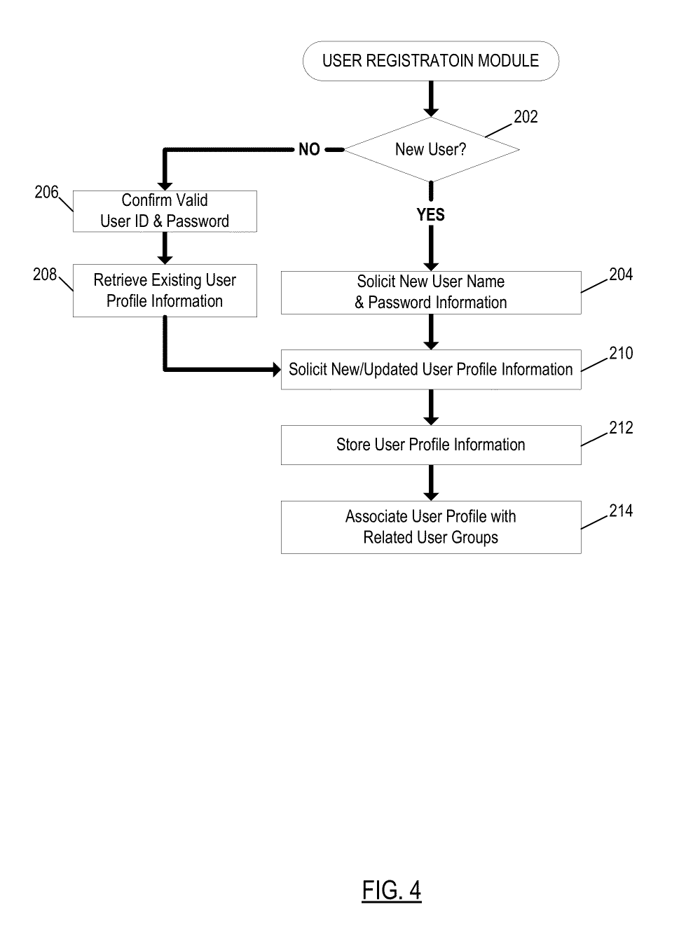

FIG. 4 illustrates exemplary steps executed by the user registration module 200 according to one embodiment. Beginning at step 202, the user registration module 200 first determines whether the user is a new user (e.g., based on whether the user has entered an existing and valid ID and password at the home page, or if the user has requested new registration via the home page). If the user is a new user, the user registration module 200 proceeds to step 204. At step 204, the user registration module 200 asks the user to provide a new user name and password to establish an account. Upon receipt of this information, the user registration module 200 stores the user name and password as a new user profile (e.g., in the memory storage areas of the central server 10 or database associated with the central server 10).

If the user is an existing user, the user registration module 200 moves to step 206, where it confirms that the user ID and password received at the home page is valid. The user registration module 200 then moves to step 208, where it retrieves existing user profile information. Next, at step 210, the user registration module 200 solicits new or updated user profile information from the user. This user profile information may include, for example, the user's name, home address, and employment information. In certain embodiments, the user profile information may also include group information indicating any related groups the user is a member of (e.g., a family name or ID, employment division or group, etc.). Next, at step 212 the user registration module 200 stores and/or updates the user profile information. Finally, at step 214, the user registration module 200 associates the user's profile with any related user groups based on any group information received during the user registration process.

### Data Capture Module

According to various embodiments, the data capture module 400 is generally configured for soliciting and capturing user consumption data relating to a user's consumption of various resources. In various embodiments, the user consumption data is later used by the central server to calculate a user's (or group's) environmental footprint. Accordingly, in response to user selection of the survey link 104 of the user interface home page, the central server 10 is configured to execute the data capture module 400.

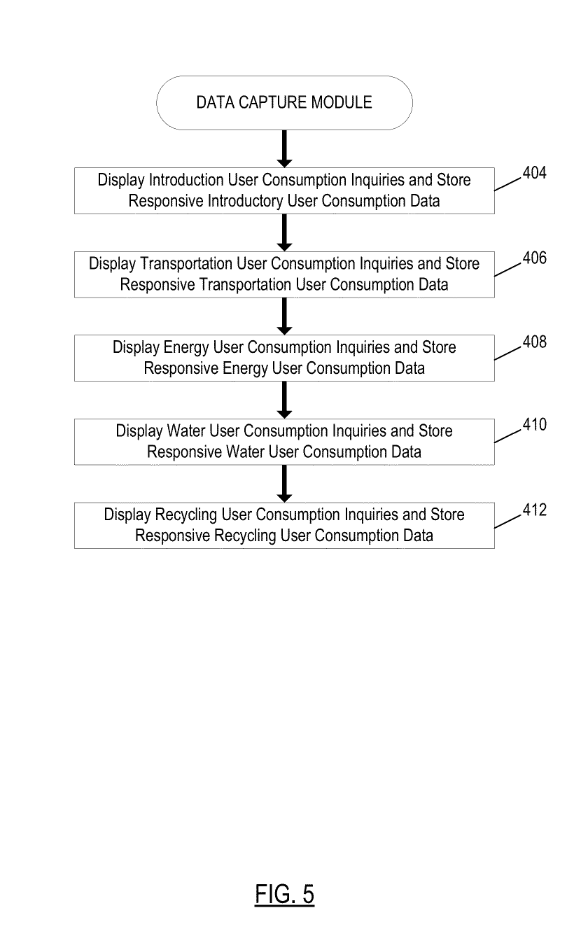

FIG. 5 illustrates exemplary steps executed by the data capture module 400 according to one embodiment. Beginning at step 404, the data capture module 400 displays one or more introduction user consumption inquiries to solicit initial user consumption data from the user. In various embodiments, the initial user consumption inquiries may relate to general information pertaining to resources consumed by the user, such as the user's primary household heating source. The data capture module 400 then stores the initial user consumption data received from the user (e.g., in the one or more memory storages areas of the server or an associated database).

Next, at step 406, the data capture module 400 displays one or more transportation user consumption inquiries to solicit transportation user consumption data from the user. In various embodiments, the transportation user consumption inquiries may relate to the user's consumption of fuel or other resources in relation to the user's transportation habits. The data capture module 400 then stores the transportation user consumption data received from the user.

Next, at step 408, the data capture module 400 displays one or more energy user consumption inquiries to solicit energy user consumption data from the user. In various embodiments, the energy user consumption inquiries may relate to the user's consumption of electricity, gas, or other resources in relation to heating, cooling, lighting, and/or running appliances in the user's home. The data capture module 400 then stores the energy user consumption data received from the user.

Next, at step 410, the data capture module 400 displays one or more water user consumption inquiries to solicit water user consumption data from the user. In various embodiments, the water user consumption inquiries may relate to the user's consumption of water in the user's home (e.g., through showering, washing, watering the lawn, etc.). The data capture module 400 then stores the water user consumption data received from the user.

Next, at step 412, the data capture module 400 displays one or more recycling user consumption inquiries to solicit recycling user consumption data from the user. In various embodiments, the recycling user consumption inquiries may relate to the amount of waste generated by the user (e.g., disposed plastic containers, newspapers, etc.) and the corresponding amount of the waste that is recycled. The data capture module 400 then stores the recycling user consumption data received from the user.

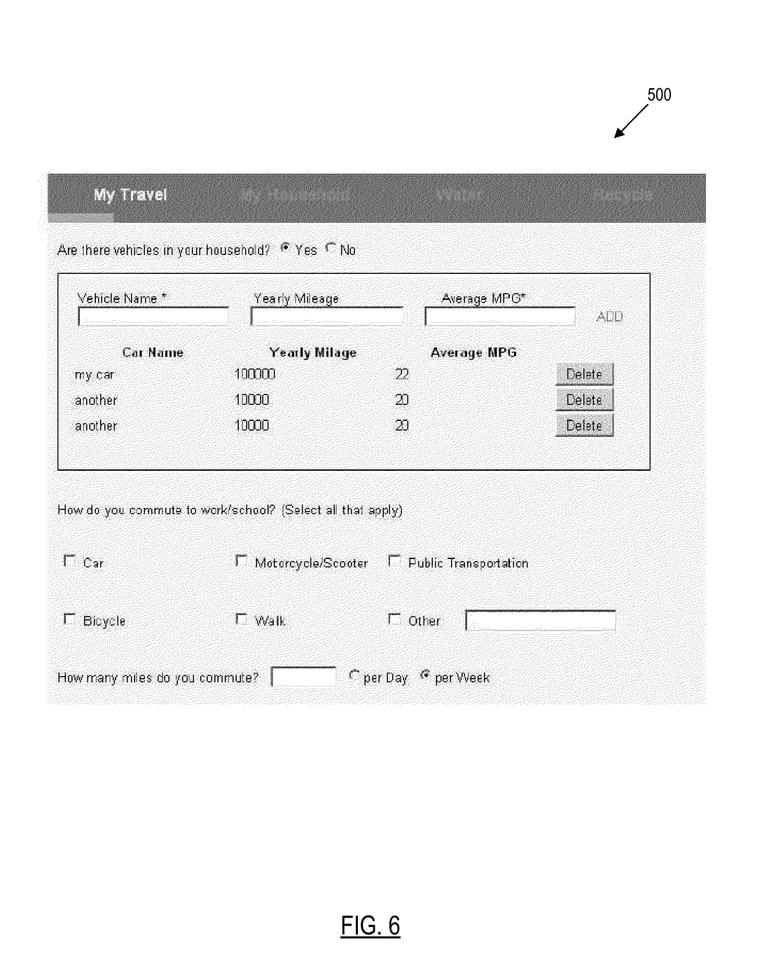

As will be appreciated from the description herein, the various user consumption inquiries presented in relation to steps 404-412 may be provided via one or more user interface pages, which may present one or more inquiries in association with data fields or drop-down menus that permit the user to provide responsive user consumption data. As one example, FIG. 6 illustrates a travel user consumption inquiry page 500 of the graphical user interface according to one embodiment. As shown in FIG. 6, the exemplary travel user consumption inquiry page 500 includes fields for the user to indicate the number of vehicles in the user's household, the type of vehicle, the yearly mileage of each vehicle, the average miles-per-gallon of the vehicle, the distance traveled by the user, and other modes of transportation used by the user. In various embodiments, the user may populate the various data fields with transportation user consumption data, which may then be stored by the data capture module 400. Additionally, as will be appreciated from the description herein, the user consumption data may be provided in any suitable format including, but not limited to, numerical value data (e.g., gallons of water used or miles driven) and user-selection data (e.g., user selection of yes/no option or all/most/some/none options, which may associated with preprogrammed values by the central server 10).

According to various embodiments, the data capture module 400 may be configured to execute the various steps 404-412 by displaying the user consumption inquiries and receiving the user consumption data detailed in Appendix A below. As will be appreciated from Appendix A, various embodiments of the data capture module 400 may be configured to present any relevant user consumption inquiries and capture any responsive user consumption data via the graphical user interface.

### User Incentive Module

According to various embodiments, the user incentive module 600 is generally configured for providing a plurality of impact reduction goals to a user, the completion of which would generally reduce the user's environmental footprint. In addition, the user incentive module 600 enables users to indicate the completion of one or more of the impact reduction goals, which the user incentive module may store as user completion data to be used in calculating revised user impact values. Accordingly, in response to user selection of the goals link 106 of the user interface home page, the central server 10 is configured to execute the user incentive module 600.

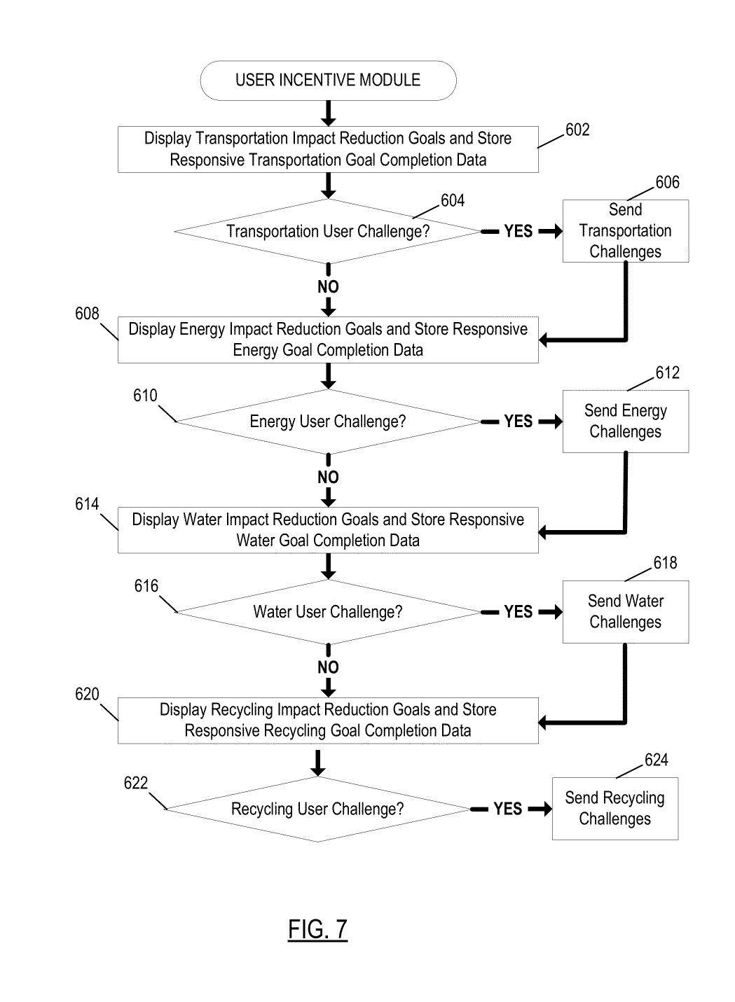

FIG. 7 illustrates exemplary steps executed by the user incentive module 600 according to one embodiment. Beginning at step 602, the user incentive module 600 displays one or more transportation impact reduction goals. In various embodiments, each of the transportation impact reduction goals may relate to an action the user may take to reduce their consumption of transportation resources (e.g., observing all speed limits to improve fuel efficiency). The user incentive module 600 also displays user input fields where the user may indicate that one or more of the transportation impact reduction goals have been completed, as well as a link enabling the user to “challenge” other users to also complete the goal. The user incentive module 600 then stores any received user input as transportation user completion data (e.g., in the one or more memory storages areas of the server or an associated database).

Next, at step 604, the user incentive module 600 determines whether the user has challenged any other users to complete a transportation impact reduction goal. If the user has indicated a challenge, the user incentive module 600 moves to step 606 where it generates a message that is sent to the user specified in the challenge. For example, in certain embodiments, the user may elect to challenge an entire user group (e.g., a household or work unit) or an individual user. The “challenge” message may be transmitted to an inbox or other field provided when the challenged user logs in to his or her account. Subsequently, the challenged user may also indicate whether the challenge has been completed and the user incentive module 600 will update that user's goal completion data as well.

Next, at step 608, the user incentive module 600 displays one or more energy impact reduction goals. In various embodiments, each of the energy impact reduction goals may relate to an action the user may take to reduce their consumption of home energy resources (e.g., turning down the thermostat to 68 degrees or lower). The user incentive module 600 also displays user input fields where the user may indicate that one or more of the energy impact reduction goals have been completed, as well as a link enabling the user to “challenge” other users to also complete the goal. The user incentive module 600 then stores any received user input as energy user completion data. Next, at step 610, the user incentive module 600 determines whether the user has challenged any other users to complete an energy impact reduction goal. If the user has indicated a challenge, the user incentive module 600 moves to step 612 and generates a message that is sent to the user specified in the challenge.

Next, at step 614, the user incentive module 600 displays one or more water impact reduction goals. In various embodiments, each of the water impact reduction goals may relate to an action the user may take to reduce their consumption of water in the home (e.g., buy front loading clothes washing machine). The user incentive module 600 also displays user input fields where the user may indicate that one or more of the water impact reduction goals have been completed, as well as a link enabling the user to “challenge” other users to also complete the goal. The user incentive module 600 then stores any received user input as water user completion data. Next, at step 616, the user incentive module 600 determines whether the user has challenged any other users to complete a water impact reduction goal. If the user has indicated a challenge, the user incentive module 600 moves to step 618 and generates a message that is sent to the user specified in the challenge.

Next, at step 620, the user incentive module 600 displays one or more recycling impact reduction goals. In various embodiments, each of the recycling impact reduction goals may relate to an action the user may take to reduce their generation of waste (e.g., compost food waste). The user incentive module 600 also displays user input fields where the user may indicate that one or more of the recycling impact reduction goals have been completed, as well as a link enabling the user to “challenge” other users to also complete the goal. The user incentive module 600 then stores any received user input as recycling user completion data. Next, at step 622, the user incentive module 600 determines whether the user has challenged any other users to complete a recycling impact reduction goal. If the user has indicated a challenge, the user incentive module 600 moves to step 624 and generates a message that is sent to the user specified in the challenge.

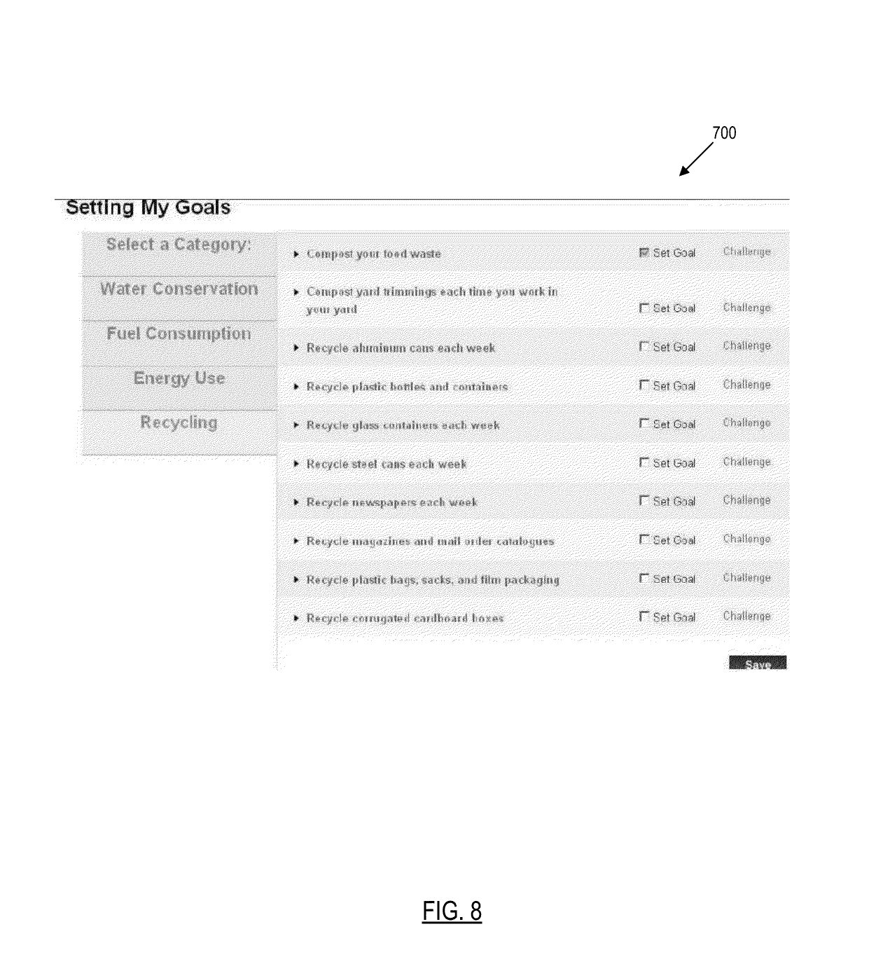

As will be appreciated from the description herein, the various impact reduction goals presented in relation to steps 602-624 may be provided via one or more user interface pages, which may present one or more goals in association with data fields or drop-down menus that permit the user to provide responsive goal completion data (e.g., an indication that a particular goal has been completed). As one example, FIG. 8 illustrates a recycling impact reduction goal page 700 of a graphical user interface according to one embodiment. As shown in FIG. 8, the exemplary recycling impact reduction goal page 700 includes fields for the user to set various recycling impact reduction goals. After setting the goals, the user interface provides fields for the user to subsequently indicate completion of the impact reduction goals. In addition, as shown in FIG. 8, the exemplary recycling impact reduction goal page 700 includes various links enabling a user to challenge other users or groups to complete a particular impact reduction goal.

According to various embodiments, the user incentive module 600 may be configured to execute the various steps 602-624 by displaying the impact reduction goals and receiving the goal completion data detailed in Appendix B below. In certain embodiments, the user incentive module 600 may be configured to present all of the impact reduction goals listed in Appendix B. In other embodiments, the user incentive module 600 may be configured to identify certain impact reduction goals pertaining to the reduction of emissions in an area where the user exceeds a predefined amount (e.g., where a user's consumption of fuel and corresponding transportation emissions are higher than a national average). As will be appreciated from Appendix B, various embodiments of the user incentive module 600 may be configured to present any relevant impact reduction goals and capture any responsive user goal completion data via the graphical user interface.

### User Impact Module

According to various embodiments, the user impact module 800 is generally configured for calculating various user impact values based on the user consumption data captured by the data capture module 400. In various embodiments, the calculated user impact values provide a quantitative assessment of the user's environmental footprint (e.g., in terms of pounds of CO₂ produced). In addition, the user impact module 800 may be configured to calculate group impact values for any groups a particular user is associated with, thereby providing a quantitative assessment of the group's environmental footprint. Furthermore, user impact module 800 is also configured for calculating revised user impact values that take into account the user's completion of one or more impact reduction goals, thereby providing a quantitative assessment of the user's reduction in his or her environmental footprint as a result of completing various impact reduction goals. Accordingly, in response to user selection of the footprint link 108 of the user interface home page, the central server 10 is configured to execute the user impact module 800.

Beginning at step 802, the user impact module 800 retrieves transportation user consumption data associated with the logged-in user (e.g., the transportation user consumption data captured by the data capture module 400). Based on the transportation user consumption data, the user impact module 800 calculates and stores various transportation user impact values. For example, in one embodiment, the user impact module 800 is configured to calculate the total amount of CO₂ emitted by the user's consumption of transportation-related resources (e.g., lbs of CO₂). In other embodiments, the user impact module 800 may also be configured to calculate the amount of CO₂ emitted as a result of each action indicated by the transportation user consumption data (e.g., lbs of CO₂ emitted due to daily work commute).

Next, at step 804, the user impact module 800 retrieves energy user consumption data associated with the logged-in user (e.g., the energy user consumption data captured by the data capture module 400). Based on the energy user consumption data, the user impact module 800 calculates and stores various energy user impact values. For example, in one embodiment, the user impact module 800 is configured to calculate the total amount of CO₂ emitted by the user's consumption of energy-related resources (e.g., lbs of CO₂). In other embodiments, the user impact module 800 may also be configured to calculate the amount of CO₂ emitted as a result of each action indicated by the energy user consumption data (e.g., lbs of CO₂ emitted due to daily electric power consumption).

Next, at step 806, the user impact module 800 retrieves water user consumption data associated with the logged-in user (e.g., the water user consumption data captured by the data capture module 400). Based on the water user consumption data, the user impact module 800 calculates and stores various water user impact values. For example, in one embodiment, the user impact module 800 is configured to calculate the total amount of water used by the user (e.g., gallons per month or year). In other embodiments, the user impact module 800 may also be configured to calculate the amount of water used as a result of each action indicated by the water user consumption data (e.g., gallons of water used due to daily lawn watering).

Next, at step 808, the user impact module 800 retrieves recycling user consumption data associated with the logged-in user (e.g., the recycling user consumption data captured by the data capture module 400). Based on the recycling user consumption data, the user impact module 800 calculates and stores various recycling user impact values. For example, in one embodiment, the user impact module 800 is configured to calculate the total amount of CO₂ emissions saved by the user's recycling of various waste (e.g., lbs of CO₂ avoided). In other embodiments, the user impact module 800 may also be configured to calculate the amount of CO₂ saved as a result of each action indicated by the recycling user consumption data (e.g., lbs of CO₂ avoided by recycling newspapers).

Next, at step 810, the user impact module 800 calculates and stores overall user impact values for the user. For example, in one embodiment, the user impact module 800 is configured to calculate the total amount of CO₂ emitted by the user (e.g., based on the total transportation emissions and home emissions calculated, and less the saved emissions due to recycling). Next, the user impact module 800 moves to step 812, where it determines whether goal completion data has been stored for the user. If goal completion data has been stored, the user impact module 800 moves to step 814, where it retrieves the goal completion data stored for the user and calculates revised user impact values for the user. For example, where the user has indicated he or she is now using a front loading washer, the user impact module 800 will estimate the energy and water savings associated with that purchase and calculate revised energy impact values and water impact values for the user. Revised user impact values may be performed in this way for all impact reduction goals completed by the user.

Next, at step 816, the user impact module 800 determines whether the user is associated with a user group. If the user is associated with a user group, the user impact module moves to step 818, where it retrieves user impact values for all users in the group and aggregates the user impact values in order to calculate one or more group impact values for the user group (e.g., total lbs of CO₂ emitted by all users in the group, average amount of CO₂ emitted by users in the group).

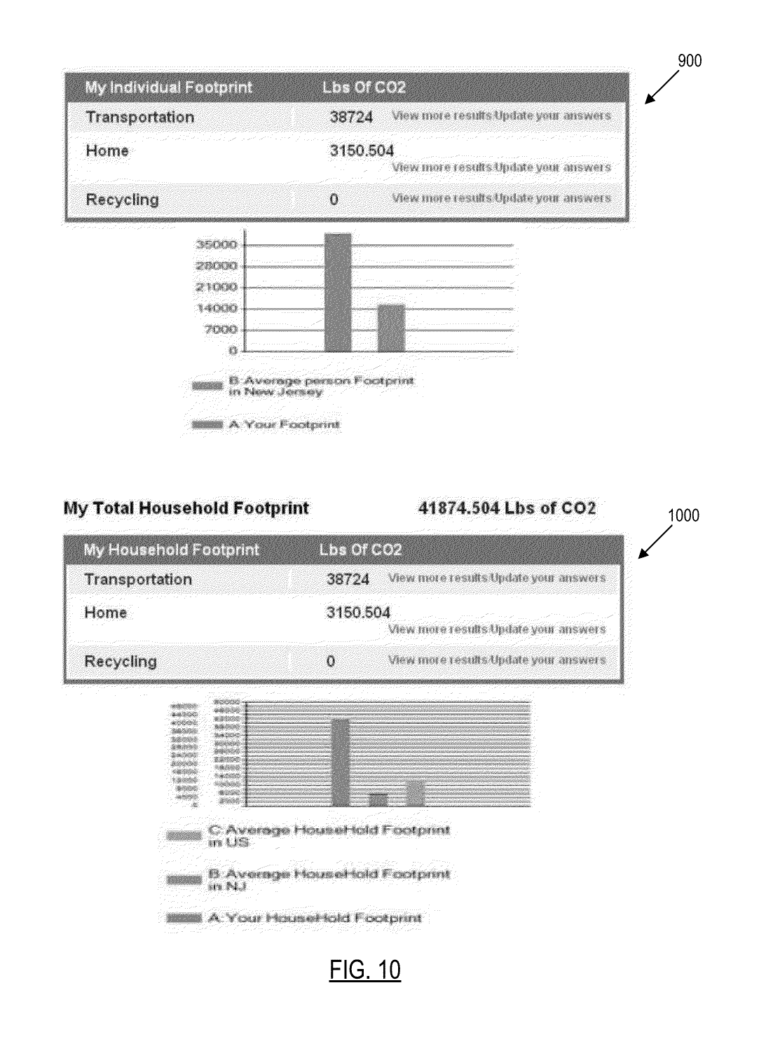

As will be appreciated from the description herein, the user impact values, revised user impact values, and group impact values calculated in relation to steps 802-818 may be indicated to a user via one or more user interface pages. As one example, FIG. 10 illustrates a user footprint page 900 and group footprint page 1000 of the graphical user interface. As shown in FIG. 10, the user footprint page 900 indicates the total amount of CO₂ emitted by a user, as well as the amount of CO₂ emitted due to consumption of transportation-related resources, the amount of CO₂ emitted due to consumption of home energy-related resources, and the amount of CO₂ avoided due to recycling. In other embodiments, the user footprint page 900 may also indicate the amount of water used by the user and indicate any revised user impact values determined by the system. Additionally, as shown in FIG. 10, the group footprint page 1000 indicates the total amount of CO₂ emitted by the user's group, as well as the amount of CO₂ emitted by the group due to consumption of transportation-related resources, the amount of CO₂ emitted due to consumption of home energy-related resources, and the amount of CO₂ avoided due to recycling. In other embodiments, the group footprint page 1000 may also indicate the amount of water used by the group and indicate any revised user impact values determined by the system.

According to various embodiments, the user impact module 800 may be configured to execute the various steps 802-818 by performing calculations based on environmental conversion factors and other data provided by reliable data sources. For example, in various embodiments, the various calculations of user impact values noted above may be performed in accordance with standards, equations, and other data provided by the United States Environmental Protection Agency, the United States Department of Energy, the Battelle Memorial Institute, the Greenhouse Gas Protocol®, the World Resources Institute, the World Business Council for Sustainable Development, and various other sources. Additionally, the calculations of revised user impact values may be performed in accordance with the assumptions and data sources noted in Appendix B below.

### Conclusion

As will be appreciated from the description herein, the environmental impact analysis system 2 may be embodied in various forms while providing the functionalities described herein. For example, in certain embodiments the system may be implemented into one or more social media environments and may be configured to link user impact data associated with various users of a given social media platform. In such embodiments, users may send impact reduction goal challenges using user connectivity features provided by the social media platform.

Indeed, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

APPENDIX A
Exemplary User Consumption Inquiries
The Basics

| | |
|---|---|
| How many people live in your home? | Enter number |
| What is your zip code? | Enter zip code |
| What is your household's primary heating source? | Select one |
| | Gas |
| | Oil |
| | Electric |
| | Propane |
| | Wood |
| | Coal |
| | None |

Transportation

| | |
|---|---|
| How do you commute to work? | Select one |
| | Car |
| | Motorcycle/Scooter |
| | Public transportation |
| | Bicycle |
| | Walk |
| | Other |
| How many vehicles are in your household? | Enter number |
| | Vehicle #N |
| How many miles do you drive per (Select one): | Enter number |
| Week | |
| Year | |
| Month | |
| How many miles a day do you commute? | Enter number |
| How many miles a day do you carpool? | Enter number of miles |
| If yes, how many people do you carpool with? | Enter number of riders |
| On average, how many gallons of fuel do you buy annually | Vehicle #N |
| for your recreational/leisure vehicle? (If you do not own, | Enter number |
| skip this section) | |
| How many airline flights do you take in an average year | |
| (personal flights only)? | |
| Short Haul/One Way (under 1.5 hrs) | Enter number |
| Medium Haul/One Way (1.5-4 hrs.) | Enter number |
| Long Haul/One Way (4-6 hrs.) | Enter number |
| Extended Haul/One Way (6-12 hrs) | Enter number |
| Super-Extended (12+ hrs) | Enter number |
| How many hours do you spend in a typical month on a: | |
| Streetcar, LRT, Subway | Enter hours |
| Public Bus | Enter hours |
| Commuter Train | Enter hours |
| Inter-City Train | Enter hours |
| Inter-City Bus | Enter hours |
| Bicycle | Enter hours |

Home Energy

| | |
|---|---|
| How much natural gas does your household use per month? | |
| If you enter your monthly consumption in thousands of cubic | |
| feet, you'll get a more accurate estimate. If you enter dollars, | |
| our calculations assume that you pay $14.14/thousand cubic | |
| feet. | |
| $70 is about average in the United States for a household of | |
| two people. | |
| Select one: | |
| dollars | Enter number |
| thousand cubic feet | Enter number |
| therms | Enter number |
| How much fuel oil does your household use per month? | Enter number |
| Divide your annual fuel oil consumption (in gallons or | |
| dollars) by 12 to obtain a monthly average. If you enter your | |
| average monthly fuel oil use in gallons, you'll get a more | |
| accurate estimate. If you enter dollars, our calculations | |
| assume that you pay $2.78/gallon. | |
| $90 is about average in the United States for a household of | |
| two people. | |
| How much propane does your household use per month? | Enter number |
| If you enter your monthly propane use in gallons, you'll get a | |
| more accurate estimate. If you enter dollars, our calculations | |
| assume that you pay $2.19/gallon. | |
| $80 is about average in the United States for a household of | |
| two people. | |
| Select one: | |
| Dollars | Enter number |
| Gallons | Enter number |
| How much electricity does your household use per month? | |
| $70 is about average in the United States for a household of | |
| two people | |
| Select one: | |
| Dollars | Enter number |
| Kilowatt Hours | Enter number |
| Do you use Compact Fluorescent Light (CFL) bulbs? | Yes/No |

Water

| | |
|---|---|
| How much water does your household typically use in a | |
| year? | |
| The average American household uses 60,000 gallons of | |
| water per year. | |
| Gallons/year | Enter Number |
| Don't know - use average | Calculation |
| Do you water your yard? | Yes/No |
| Do you own a swimming pool? | Yes/No |
| Do you have city/community water or well water? | Select one |
| | City/Community water |
| | Well Water |

Recycling/Waste

| | |
|---|---|
| Do you compost? | Yes/No |
| Based on the number of people in your household, the box at | Calculation (lbs. of |
| right shows your estimated greenhouse gas emissions from | CO2) |
| waste. | |
| However, if you currently recycle certain materials, your | |
| waste emissions may be lower. | |
| In a typical week my household uses: | |
| Number of aluminum/steel cans | Enter number |
| How much do you recycle? | Select one |
| | All |
| | Most |
| | Some |
| | None |
| Number of plastic containers | Enter number |
| How much do you recycle? | Select one |
| | All |
| | Most |
| | Some |
| | None |
| Number of glass containers | Enter number |
| How much do you recycle? | Select one |
| | All |
| | Most |
| | Some |
| | None |
| Number of newpapers | Enter number |
| How much do you recycle? | Select one |
| | All |
| | Most |
| | Some |
| | None |
| Number of magazines | Enter number |
| How much do you recycle? | Select one |
| | All |
| | Most |
| | Some |
| | None |
| Average number of sheets of paper (e.g., for home printer) | Enter number |
| How much do you recycle? | Select one |
| | All |
| | Most |
| | Some |
| | None |

APPENDIX B
Exemplary Energy Impact Reduction Goals:

| Goal 1 | User timers or sensors to turn off lights when you leave a room |
|---|---|
| Category | Energy |
| Difficulty | 2 trees |
| Additional | Turning off just one 60-watt incandescent bulb, that would have been left on |
| Information | for 8 hours, saves approximately $15 annually. |
| (Expanded | |
| View) | |
| User Input | total wattage of light bulbs; number of hours per day they will be turned off; |
| | electricity rate in $/kWh |
| Carbon | pounds of CO2 emissions avoided annually = kWh per day [(total wattage × |
| Calculation | hrs per day)/1000] × 365 days in a year × 1.52 |
| Assumptions | kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| Sources | US EPA ENERGY STAR Program |
| | http://www.energystar.gov/index.cfm?c=products.es_at_home_tips_renters10 |
| User Notes | Ascertaining your electricity or gas rate isn't always easy: consider providing |
| | tips for finding it on a typical utility bill. |
| Goal 2 | Power-manage computers |
| Category | Energy |
| Difficulty | 1 Tree/1 Dollar Sign |
| Additional | Saves roughly 500 kWh a year for a desktop, 147 kWh a year for a laptop. |
| Information | |
| (Expanded | |
| View) | |
| User Input | Number of desktop computers in your home |
| | Number of notebook/tablet computers in your home; |
| Carbon | pounds of CO2 emissions avoided annually = ([number of desktops] × |
| Calculation | 500 kWh) + ([# of laptops] × 147 kWh) × 1.52 |
| Assumptions | 1. Computers are generally left on nights and weekends |
| | 2. kWh savings can be converted into lbs of CO2 avoided with this |
| | formula: [savings in kWh] × 1.52. (Source for conversion factor: |
| | http://www.epa.gov/greenpower/pubs/calcmeth.htm: 6.8956 × 10⁻⁴ |
| | metric tons CO₂/kWh × 2204.62262 lbs/metric ton = 1.52) |
| Sources | http://www.energystar.gov/lowcarbonit; see power management savings |
| | calculator under “Quick Links”. Enter “1” in cell D11 and click on results tab |
| | to see 500 kWh savings for a desktop. Enter “1” in cell E11 and click on |
| | results tab to see 147 kWh savings for a notebook. |
| User Notes | 1. Provide instructions for power managing computers by linking to the |
| | following ENERGY STAR webpage: |
| | http://www.energystar.gov/index.cfm?c=power_mgt.pr_power_mgt_users |
| | 2. Ascertaining your electricity or gas rate isn't always easy: consider |
| | providing tips for finding it on a typical utility bill. |
| Goal 3 | Swap out your incandescent light bulbs for compact fluorescent lights |
| | (CFLs) |
| Category | Energy |
| Difficulty | 2 Trees |
| Additional | Saves roughly 51 kWh per bulb annually, or about $6 annually and more than |
| Information | $40 over its lifetime. |
| (Expanded | |
| View) | |
| User Input | # of bulbs replaced; |
| Carbon | pounds of CO2 emissions avoided annually = [# of bulbs replaced] × 51 kWh × |
| Calculation | 1.52 |
| Assumptions | Replacing a 60 W bulb with a 13 W CFL that is used about 3 hours per day. |
| Sources | 1. http://www.energystar.gov/index.cfm?fuseaction=find_a_product.showProductGroup&pgw_code=LB; |
| | also see the ENERGY STAR lighting |
| | calculator at same link |
| | 2. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| User Notes | Ascertaining your electricity or gas rate isn't always easy: consider providing |
| | tips for finding it on a typical utility bill. |
| Goal 4 | Lower the temperature on your water heater by 10 degrees F. |
| Category | Energy |
| Difficulty | 2 Dollar Signs |
| Additional | For each 10 degree F. reduction in water temperature, you can save between |
| Information | 3%-5% in water-heating energy costs. |
| (Expanded | |
| View) | |
| User Input | Completed/Not Completed |
| Carbon | E.g., Use 10 degree in this calculation where Goal is to drop the temperature |
| Calculation | by 10 degrees. |
| | pounds of CO2 emissions avoided annually if electric = ([# of degrees F. that |
| | the thermostat setting was lowered] ÷ 10) × .04 × 5082 kWh × 1.52 |
| | pounds of CO2 emissions avoided annually if gas = ([# of degrees F. that the |
| | thermostat setting was lowered] ÷ 10) × .04 × 253 therms × 11 |
| Assumptions | 1. 4% savings for each 10° F. reduction in water temperature |
| | 2. Annual energy use for electric water heater: 5082 kWh |
| | 3. Annual energy use for gas water heater: 253 therms |
| | 4. Water heater has an efficiency that just meets the national minimum |
| | standard for gas and electric water heaters |
| | 5. Average daily water usage = 64 gallons of hot water |
| Sources | 1. http://www.energysavers.gov/your_home/water_heating/index.cfm/mytopic=13090; |
| | 2. http://www1.eere.energy.gov/femp/technologies/eep_waterheaters_calc.html. |
| | Enter “1” in the “Quantity of Water Heaters to be Purchased” field |
| | and press the “Calculate” button. In the “Base Model” column, Annual |
| | Energy Use is 5082 kWh. To obtain Annual Energy Use for a gas water |
| | heater, press the reset button, then select “Gas” in the “Type of Water |
| | Heater” field. Enter “1” in the “Quantity of Water Heaters to be |
| | Purchased” field and press the “Calculate” button. In the “Base Model” |
| | column, Annual Energy Use is 253 therms. |
| | 3. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| | 4. Natural gas savings in therms can be converted into lbs of CO2 avoided |
| | with this formula: [savings in therms] × 11 (Source for conversion factor: |
| | http://www.epa.gov/cleanenergy/energy-resources/calculator.html) |
| User Notes | Ascertaining your electricity or gas rate isn't always easy: consider providing |
| | tips for finding it on a typical utility bill. |
| Goal 5 | Insulate your water heater tank |
| Category | Energy |
| Difficulty | 2 Trees |
| Additional | Adding insulation to your water heater's storage tank can reduce standby heat |
| Information | losses by 25%-45%. This will save around 4%-9% in water heating costs. |
| (Expanded | |
| View) | |
| User Input | Completed/Not Completed |
| Carbon | pounds of CO2 emissions avoided annually if electric = .065 × 5082 kWh × |
| Calculation | 1.52 |
| | pounds of CO2 emissions avoided annually if gas = .065 × 253 therms × 11 |
| Assumptions | 1. 6.5% savings (median of range presented by source, below) |
| | 2. Annual energy use for electric water heater: 5082 kWh |
| | 3. Annual energy use for gas water heater: 253 therms |
| | 4. Water heater has an efficiency that just meets the national minimum |
| | standard for gas and electric water heaters |
| | 5. Average daily water usage = 64 gallons of hot water |
| Sources | 1. http://www.energysavers.gov/your_home/water_heating/index.cfm/mytopic=13070; |
| | 2. http://www1.eere.energy.gov/femp/technologies/eep_waterheaters_calc.html |
| | 3. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| | 4. Natural gas savings in therms can be converted into lbs of CO2 avoided |
| | with this formula: [savings in therms] × 11 (Source for conversion factor: |
| | http://www.epa.gov/cleanenergy/energy-resources/calculator.html) |
| User Notes | Ascertaining your electricity or gas rate isn't always easy: consider providing |
| | tips for finding it on a typical utility bill. |
| Goal 6 | Hang up one load of laundry each week instead of using the clothes dryer |
| Category | Energy |
| Difficulty | 2 Trees/2 Dollars |
| User Input | # of laundry loads air-dried per week; electric or gas clothes dryer; |
| Carbon | pounds of CO2 emissions avoided annually if electric = [# of laundry loads |
| Calculation | air-dried per week] × 3.3 kWh × 52 × 1.52 |
| | pounds of CO2 emissions avoided annually if gas = ([# of laundry loads air- |
| | dried per week] × .22 therms × 52 × 11) + ([# of laundry loads air-dried per |
| | week] × .21 kWh × 52 × 1.52 |
| Assumptions | 1. 45 minutes per load |
| | 2. Electric model uses 3.3 kWh per load |
| | 3. Gas model uses 0.22 therms + 0.21 kWh per load (gas model still uses |
| | electricity to spin the drum). See assumptions at the bottom of the |
| | “Electric vs. Gas Dryers” calculator at the first link below. |
| Sources | 1. http://michaelbluejay.com/electricity/dryers.html |
| | 2. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| | 3. Natural gas savings in therms can be converted into lbs of CO2 avoided |
| | with this formula: [savings in therms] × 11 (Source for conversion factor: |
| | http://www.epa.gov/cleanenergy/energy-resources/calculator.html) |
| User Notes | Ascertaining your electricity or gas rate isn't always easy: consider providing |
| | tips for finding it on a typical utility bill. |
| Goal 7 | Set your air conditioner thermostat to 78 degrees or higher. |
| Category | Energy |
| Difficulty | 1 Tree/1 Dollar Sign |
| Additional | Each degree you raise your thermostat will reduce your cooling energy use by |
| Information | roughly 3 percent. |
| (Expanded | |
| View) | |
| User Input | # of degrees you raised your thermostat to get to 78°; |
| | Typical monthly electric bill during the cooling season in $ |
| | Typical monthly electric bill in between heating and cooling seasons when |
| | neither the heat or AC is on in $; number of months you typically run the AC; |
| | electricity rate in $/kWh |
| Carbon | $ saved annually = [# of degrees you raised your thermostat] × 0.03 × |
| Calculation | ([typical monthly electric bill during the cooling season in $] − [typical |
| | monthly electric bill in between heating and cooling seasons]) × [number of |
| | months you typically run the AC] |
| | Pounds of CO2 emissions avoided annually = [$ saved annually] ÷ [electricity |
| | rate in $/kWh] × 1.52 |
| Assumptions | Each degree will reduce your cooling energy use by 3% |
| Sources | 1. http://www.ag.ny.gov/bureaus/consumer_frauds/tips/energy_conservation.html |
| | 2. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| User Notes | Ascertaining your electricity or gas rate isn't always easy: consider providing |
| | tips for finding it on a typical utility bill. |
| Goal 8 | Turn down the thermostat on your heater to 68 degrees or lower during |
| | the cooler months |
| Category | Energy |
| Difficulty | 1 Tree/1 Dollar Sign |
| Additional | For every degree you lower your heat in the 60-degree to 70-degree range, |
| Information | you'll save up to 5 percent on heating costs. |
| (Expanded | |
| View) | |
| User Input | # of degrees you lowered your thermostat; |
| | typical electric bill during the heating season in $; |
| | typical electric bill in between heating and cooling seasons when neither the |
| | heat or AC is on in $; |
| | number of months during which the heat is “mostly on”; electricity rate in |
| | $/kWh; |
| | if gas or oil heat, typical monthly gas or oil bill during the heating season in |
| | $; typical monthly gas or oil bill in between heating and cooling seasons |
| | when neither the heat or AC is on in $; gas rate in $/therm; oil rate in $ per |
| | gallon |
| Carbon | If electric heat, skip to part 2 of this calculation below. If gas or oil heat: |
| Calculation | 1. $ saved annually = [# of degrees you lowered your thermostat] × 0.05 × |
| | ([typical monthly bill during the heating season] − [typical monthly bill in |
| | between heating and cooling seasons]) × [number of months during which |
| | the heat is mostly on]. Add to $ saved annually in electricity, below, per |
| | assumption #1. |
| | 2. $ saved annually = [# of degrees you lowered your thermostat] × 0.05 × |
| | ([typical monthly electric bill during the heating season] − [typical |
| | monthly electric bill in between heating and cooling seasons]) × [number |
| | of months during which the heat is mostly on] |
| | pounds of CO2 emissions avoided annually = [$ saved annually in electricity] ÷ |
| | [electricity rate in $/kWh] × 1.52 |
| | If gas heat, add the following: [$ saved annually in gas] ÷ [gas rate in |
| | $/therm] × 11 |
| | If oil heat, add the following: [$ saved annually in oil] ÷ [heating oil rate in |
| | $/gallon] × 10,180 × .002205 |
| Assumptions | 1. For those with gas or oil heat, assumes any increase in electricity use |
| | during the heating months is due to fans running in a central heating |
| | system. |
| | 2. Oil heat is essentially diesel fuel. |
| | 3. Heating oil savings in gallons can be converted into lbs of CO2 avoided |
| | with this formula: 10,180 grams CO2 (per gallon oil) × .002205 grams per |
| | lb. |
| Sources | 1. http://www.consumerenergycenter.org/tips/winter.html |
| | 2. http://www.epa.gov/otaq/climate/documents/420f11041.pdf |
| User Notes | |
| Goal 9 | Install ceiling fans in bedrooms and the rooms in your home that are |
| | most often occupied |
| Category | Energy |
| Difficulty | 3 Dollar Signs |
| Additional | Fans can make you feel 3 to 8 degrees cooler, allowing you to set your AC to |
| Information | a higher temperature and still feel just as cool. |
| (Expanded | |
| View) | |
| User Input | # of degrees you raised your thermostat; |
| | Typical monthly electric bill during the cooling season in $; |
| | Typical monthly electric bill in between heating and cooling seasons when |
| | neither the heat or AC is on in $; |
| | Number of months you typically run the AC; |
| | electricity rate in $/kWh |
| Carbon | $ saved annually = [# of degrees you raised your thermostat] × 0.03 × |
| Calculation | ([typical monthly electric bill during the cooling season in $] − [typical |
| | monthly electric bill in between heating and cooling seasons]) × [number of |
| | months you typically run the AC] |
| | pounds of CO2 emissions avoided annually = [$ saved annually] ÷ [electricity |
| | rate in $/kWh] × 1.52 |
| Assumptions | 1. Ceiling fans are cheaper than you might expect: they start out around $40 |
| | at your local home improvement store, and usually cost less than a penny |
| | an hour to run. (A typical 36″/48″/52″ ceiling fan uses about 55/75/ |
| | 90 watts of electricity respectively at the top speed.) Central AC costs |
| | seventy times more to run than a fan! |
| | 2. Each degree will reduce your cooling energy use by 3%. |
| Sources | 1. http://www.ag.ny.gov/bureaus/consumer_frauds/tips/energy_conservation.html |
| | 2. http://michaelbluejay.com/electricity/cooling.html |
| | 3. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| User Notes | 1. Make sure your fan is blowing DOWN, to send air past your body, |
| | removing the hot air that surrounds your body. If your fan is blowing up, |
| | it won't do any good. For instructions on ascertaining and changing fan |
| | direction, see http://michaelbluejay.com/electricity/cooling.html. |
| | 2. Ascertaining your electricity or gas rate isn't always easy: consider |
| | providing tips for finding it on a typical utility bill. |
| Goal 10 | Buy a front-loading clothes washing machine |
| Category | Energy and Water |
| Difficulty | 3 Trees |
| Savings | Front loaders use 40-75% less water and 30-85% less energy than typical top- |
| | loaders. Front-loaders cost about $100 more than top-loaders, but common |
| | savings are $100/yr. The only time a front-loader won't pay for itself is if you |
| | already use cold water almost exclusively, and you do a lot less than the |
| | average 7.5 loads per week. |
| User Input | Completed/Not Completed |
| Carbon | pounds of CO2 emissions avoided annually = roughly 460 kWh × 1.52 = |
| Calculation | 699.2 |
| Assumptions | 1. $100 annual savings includes energy + water + water heating costs. (See |
| | “Front-loading washing machines are the way to go” at the first link |
| | below.) |
| | 2. kWh savings annually = energy savings of front-loader vs. top-loader (30-85%). |
| | That's 120-560 kWh/yr vs. 800 kWh/yr. The midpoint of 120-560 |
| | is 340 kWh, so the savings is 800-340 or 460 kWh. Sources: |
| | http://michaelbluejay.com/electricity/laundry.html and |
| | http://michaelbluejay.com/electricity/laundry-sources.html. |
| | 3. Loads per year = 392 (or about 7.5 per week). Source: US EPA |
| | ENERGY STAR Program. See |
| | http://www.energystar.gov/index.cfm?fuseaction=clotheswash.display_column_definitions. |
| | 4. kWh savings can be converted into lbs of CO2 avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| Sources | 1. http://michaelbluejay.com/electricity/laundry.html |
| | 2. http://michaelbluejay.com/electricity/laundry-sources.html |
| | 3. http://www.energystar.gov/index.cfm?fuseaction=clotheswash.display_column_definitions. |
| User Notes | It is possible to do a detailed calculation of savings based on washer type, |
| | temperature of washes, utility rates, # of loads per week, and more. (See |
| | “Laundry Costs Calculator” at |
| | http://michaelbluejay.com/electricity/laundry.html.) |

Exemplary Transportation Impact Reduction Goals:

| Goal 1 | Track your vehicle's mileage between fill-ups |
|---|---|
| Category | Transportation |
| Difficulty | One Tree |
| Additional | Records collected by Fuelclinic.com indicate a 6 percent improvement in fuel |
| Information | economy just by tracking performance and being aware of consumption. |
| (Expanded | Knowing how much you consume and save will encourage greater efficiency. |
| View) | |
| User Input | Require User to select their primary vehicle from a list of the vehicles |
| | associated to the household on the Survey. |
| | Calculation will use Annual Mileage and MPG from Survey Results to |
| | determine Carbon Calculation. |
| Carbon | pounds of CO² emissions avoided annually = |
| Calculation | Annual Miles/miles per gallon = Gallons |
| | Gallons * 19.6 = C02 Consumed * .06 |
| Assumptions | 1. Records collected by Fuelclinic.com indicate a 6 percent improvement in |
| | fuel economy just by tracking performance and being aware of |
| | consumption. Knowing how much you consume and how much you are |
| | saving will go a long way to encourage continued improvement. |
| | 2. Assumes car is powered by gasoline. Separate carbon calculations can be |
| | made for diesel vehicles (see link under sources), but diesel passenger |
| | vehicles are rare in the US. |
| | 3. All savings figures in gallons of gas can be converted into tons of CO² |
| | with this formula: [gasoline savings in gallons] × 8.92 * 10⁻³ = CO² in |
| | metric tons. Multiply metric tons by 2204.6 to get lbs. (Source for |
| | conversion factor: http://www.epa.gov/greenpower/pubs/calcmeth.htm.) |
| Sources | 1. http://www.fuelclinic.com/index.cfm?page=fuel_saving_tips. |
| | 2. For carbon dioxide emissions from diesel: http://carbonfund.org/how-we-calculate |
| | http://www.carbonfund.org/site/pages/carbon_calculators/category/Assumptions |
| User Notes | 1. Provide simple instructions for calculating fuel economy. Example: |
| | Begin keeping your fuel receipts every time you buy fuel for your vehicle. |
| | Write your current vehicle odometer reading on the receipt before you |
| | drive away from the fuel pump. Or, if your car has a trip meter, reset it to |
| | zero. In addition, you can print a blank fuel purchase record from here: |
| | https://www.fueleconomy.gov/mpg/MPG.do?action=garage. |
| | 2. For best results, always fill your tank to “FULL” - but don't overfill. |
| | You'll need at least two consecutive receipts to calculate your fuel |
| | economy. Simply subtract the odometer reading on your previous receipt |
| | from the one on your current receipt to get the number of miles you've |
| | driven since your last fill-up. Or, note the mileage on your trip meter. |
| | Divide the number of miles driven by the gallons of gas purchased at your |
| | most recent fill-up, and you have your fuel economy in miles per gallon. |
| Goal 2 | Check your tire pressure monthly |
| Category | Transportation |
| Difficulty | One Tree/One Dollar |
| Additional | This alone can reduce the average amount of fuel use by 3-4 percent. |
| Information | |
| (Expanded | |
| View) | |
| User Input | Require User to select their primary vehicle from a list of the vehicles |
| | associated to the household on the Survey. |
| | Calculation will use Annual Mileage and MPG from Survey Results to |
| | determine Carbon Calculation. |
| Carbon | pounds of CO² emissions avoided annually = |
| Calculation | Annual Miles/miles per gallon = Gallons |
| | Gallons * 19.6 = C02 Consumed * .035 |
| Assumptions | 1. Keeping tires properly inflated to the recommended tire pressure can reduce |
| | fuel use by 3-4 percent. The midpoint between 3-4 percent is 0.35. |
| | 2. All savings figures in gallons of gas can be converted into tons of CO² with |
| | this formula: [gasoline savings in gallons] × 8.92 * 10⁻³ = CO² in metric |
| | tons. Multiply metric tons by 2204.6 to get lbs. (Source for conversion |
| | factor: http://www.epa.gov/greenpower/pubs/calcmeth.htm.) |
| Sources | 1. http://www.fuelclinic.com/index.cfm?page=fuel_saving_tips |
| | 2. http://www.tire-gauge.com/How-often-tire-pressure-checked.htm |
| User Notes | 1. Under-inflated tires increase rolling resistance and reduce fuel economy. |
| | They also wear more rapidly. |
| | 2. Buy a tire pressure gauge and keep it in your car. They're inexpensive, and |
| | gas station air compressors are often missing functioning gauges. |
| | 3. Check the vehicle's door-post sticker for minimum cold tire inflation |
| | pressure. |
| | 4. Check tire pressure at least once a month and before going on a long trip. |
| | Also, don't forget to check the spare tire to ensure that it's properly inflated |
| | and ready if needed. |
| Goal 3 | Observe the speed limit/Do not drive aggressively |
| Category | Transportation |
| Difficulty | One Tree/One Dollar |
| Additional | Aggressive driving (speeding, rapid acceleration, and hard braking) wastes gas. |
| Information | It can lower your highway gas mileage 33 percent and city mileage 5 percent. |
| (Expanded | |
| View) | |
| User Input | Calculation will use Annual Mileage and MPG from Survey Results to |
| | determine Carbon Calculation. |
| Carbon | pounds of CO² emissions avoided annually = (.19 × [approx. # of gallons |
| Calculation | purchased per month] × 12 months × [estimated percent of miles driven per |
| | year]) × 8.92 * 10⁻³ × 2204.6 |
| Assumptions | 1. We acknowledge that this is an imperfect calculation because the estimated |
| | percent of highway miles driven per year vs. city miles is not the same as |
| | the estimated fuel spent for highway driving vs. city driving. |
| | 2. Assumes car is powered by gasoline. Separate carbon calculations can be |
| | made for diesel vehicles (see link under sources), but diesel passenger |
| | vehicles are rare in the US. |
| | 3. All savings figures in gallons of gas can be converted into tons of CO² with |
| | this formula: [gasoline savings in gallons] × 8.92 * 10−3 = CO² in metric |
| | tons. Multiply metric tons by 2204.6 to get lbs. (Source for conversion |
| | factor: http://www.epa.gov/greenpower/pubs/calcmeth.htm.) |
| Sources | 1. http://www.energysavers.gov/tips/driving.cfm |
| | 2. www.fueleconomy.gov/feg/drivehabits.shtml |
| | 3. http://business.edf.org/sites/business.edf.org/files/fuel-smart-driving-handbook.pdf |
| User Notes | |
| Goal 4 | Reduce idling your car by 5 minutes per day |
| Category | Transportation |
| Difficulty | One Dollar Sign |
| Additional | 0.123 gallons per day per car, or 45 gallons per year |
| Information | |
| (Expanded | |
| View) | |
| User Input | Completed/Not Completed |
| Carbon | pounds of CO² emissions avoided annually = 45 gallons × 8.92 * 10⁻³ × 2204.6 |
| Calculation | |
| Assumptions | 1. Research indicates that the average person idles their car five to 10 minutes |
| | a day. For every two minutes a car is idling, it uses about the same amount |
| | of fuel it takes to go about one mile. |
| | 2. In 2007, the weighted average fuel economy of cars and light trucks |
| | combined was 20.4 miles per gallon (FHWA 2008). |
| | 3. Fuel used during 5 minutes of idling = 2 minutes × 2.5 (to get to 5 minutes) ÷ |
| | 20.4 = 0.123 |
| Sources | 1. http://www.consumerenergycenter.org/myths/idling.html |
| | 2. http://www.thehcf.org/antiidlingprimer.html |
| | 3. http://www.edmunds.com/fuel-economy/we-test-the-tips.html |
| User Notes | 1. Idling gets you 0 miles per gallon. The best way to warm up a vehicle is |
| | to drive it. No more than 30 seconds of idling on winter days is needed. |
| | Anything more simply wastes fuel and increases emissions. If you're in a |
| | drive-through restaurant/business line or waiting for someone and you'll be |
| | parked and sitting for 10 seconds or longer . . . turn off your car's engine. |
| | (http://www.consumerenergycenter.org/myths/idling.html) |
| | 2. All gas savings figures can be converted into tons of CO² with this |
| | formula: [gasoline savings in gallons] × 8.92 * 10⁻³ = CO² in metric tons. |
| | (Multiply metric tons by 2204.6 to get lbs.) (Source for conversion factor: |
| | http://www.epa.gov/greenpower/pubs/calcmeth.htm.) |
| Goal 5 | Detach removable roof Rack |
| Category | Transportation |
| Difficulty | One Tree |
| Additional | A roof rack increases drag and can decrease your fuel economy by 5 percent or |
| Information | more. |
| (Expanded | |
| View) | |
| User Input | approximate # of gallons purchased per month; |
| | estimated # of days per month the roof rack is no longer used |
| Carbon | pounds of CO² emissions avoided annually = .05 × [approx. # of gallons |
| Calculation | purchased per month] × ([estimated # of days per month the roof rack is no |
| | longer used] ÷ 30) × 12 × 8.92 * 10⁻³ × 2204.6 |
| Assumptions | 1. Even an empty roof rack decreases your fuel economy. |
| | 2. Calculating the savings from unloading a roof rack versus removing it |
| | entirely is too complex for this application. |
| Sources | 3. http://www.energysavers.gov/tips/driving.cfm |
| | 4. http://www.cartalk.com/content/guide-better-fuel-economy |
| User Notes | |
| Goal 6 | Clean out your car |
| Category | Transportation |
| Difficulty | Easy 1 tree, 1 dollar |
| Additional | Clear out your car; extra weight decreases gas mileage by 1 percent to 2 |
| Information | percent for every 100 pounds. |
| (Expanded | |
| View) | |
| User Input | Approximate # of lbs removed from car; approximate # of gallons purchased |
| | per month; |
| Carbon | pounds of CO² emissions avoided annually = .015 × ([approx. # of lbs |
| Calculation | removed from car] ÷ 100) × [approx. # of gallons purchased per month] × 12 × |
| | 8.92 * 10⁻³ × 2204.6 |
| Assumptions | Extra weight decreases gas mileage by 1 percent to 2 percent for every 100 |
| | pounds. The midpoint between 1-2 percent is 0.15. |
| Sources | http://www.energysavers.gov/tips/driving.cfm |
| Notes | |
| Tracking | Not Applicable |
| Frequency | |
| Number of | One Time |
| Occurrences to | |
| Achieve the | |
| Goal | |
| Goal 7 | Drive a more fuel-efficient car |
| Category | Transportation |
| Difficulty | 3 trees |
| Additional | Future opportunity to provide a calculator that will allow the user to compute |
| Information | potential savings from getting a more fuel-efficient car |
| (Expanded | |
| View) | |
| User Input | Average fuel economy of current car in mpg (see Goal 1 for calculation); |
| | Average fuel economy of more fuel-efficient car in mpg; |
| | Approx. # of miles driven per month |
| | User to select when the will be completing the goal: |
| | 3 Months |
| | 6 Months |
| | 12 Months |
| Carbon | pounds of CO² emissions avoided annually = ([approx. # of miles driven per |
| Calculation | month] ÷ [average fuel economy of current car in mpg]) − ([approx. # of miles |
| | driven per month] ÷ [average fuel economy of more fuel-efficient car in mpg] × |
| | 12 × 8.92 * 10⁻³ × 2204.6 |
| Assumptions | |
| Sources | http://www.fueleconomy.gov/feg/choosing.shtml |
| User Notes | |
| Goal 8 | Change your lawnmower from gas to electric |
| Category | Transportation |
| Difficulty | Difficult 2 tree and 2 dollar sign |
| Additional | Roughly $70 a year in fuel, oil, and engine tune-ups. |
| Information | |
| (Expanded | |
| View) | |
| User Input | Completed/Not completed |
| | User to select when they will be completing the goal: |
| | 3 Months |
| | 6 Months |
| | 12 Months |
| Carbon | According to the EPA, one gas mower generates 88 lbs. of the greenhouse gas |
| Calculation | CO² and 34 lbs. of other pollutants into the air every year. |
| Assumptions | 1. Electric motors do contribute to your carbon footprint, but the amount |
| | depends on the plant in which the electricity was generated. |
| Sources | 1. http://www.peoplepoweredmachines.com/faq-environment.htm#environment |
| | 2. http://www.epa.gov/oaqps001/community/details/yardequip_addl_info.html |
| Notes | 1. According to the U.S. Environmental Protection Agency (EPA), a new gas- |
| | powered lawn mower produces as much volatile organic compounds and |
| | nitrogen oxides emissions in one hour of operation as 11 new cars each being |
| | driven for one hour. |
| | 2. Gas mowers represent 5 percent of U.S. air pollution. |
| | 3. The EPA estimates that over 17 million gallons of fuel, mostly gasoline, are |
| | spilled each year while refueling lawn equipment. That's more than all the oil |
| | spilled by the Exxon Valdez, in the Gulf of Alaska. In addition to |
| | groundwater contamination, spilled fuel that evaporates into the air and |
| | volatile organic compounds spit out by small engines make smog-forming |
| | ozone when cooked by heat and sunlight. |
| | 4. Environmentally, the best mower is the reel mower. The reel mower (or push |
| | mower) produces no pollution and leaves no carbon footprint. |
| Goal 9 | Use cruise control when you drive |
| Category | Transportation |
| Difficulty | Easy 1 dollar sign |
| Additional | Average savings of 7 percent, up to 14 percent |
| Information | |
| (Expanded | |
| View) | |
| User Input | average fuel economy of current car in mpg (see Goal 1 for calculation); |
| | approx. # of miles driven per month with cruise control on; |
| Carbon | pounds of CO² emissions avoided annually = [approx. # of miles driven per |
| Calculation | month with cruise control on] × 12 ÷ [average fuel economy of current car in |
| | mpg] × .07 × 8.92 * 10⁻³ × 2204.6 |
| Assumptions | 1. Assume savings of 7 percent. |
| Sources | http://www.edmunds.com/fuel-economy/we-test-the-tips.html |
| User Notes | 1. Cruise control smooths out the driver's accelerator input by preventing |
| | nervous “surging.” Second, it makes the driver take the long view of the |
| | road rather than reacting to every change in the traffic around them. |
| | 2. It's important to note that if you live in a mountainous area, you should not |
| | turn on cruise control: You will waste a lot of gas having your car try to |
| | keep up to the set speed while going up steep highways. It's better to |
| | simply downshift to lower gears yourself. |

Exemplary Recycling Impact Reduction Goals:

| Goal 1 | Compost your food waste |
|---|---|
| Category | Waste Reduction and Recycling |
| Difficulty | 3 trees, 2 dollar signs |
| Additional | The average American generates about 4.43 pounds of waste daily, of which |
| Information | 13.9% is food scraps. |
| (Expanded | |
| View) | |
| User Input | Completed/Not Completed |
| Carbon | Refer to this formula to calculate pounds of waste avoided annually |
| Calculation | pounds of waste avoided annually = 13.9% × 4.43 pounds per person per day × |
| | 365 days in a year |
| | pounds of CO2 emissions avoided annually = [Pounds of waste avoided |
| | annually] (as calculated above) × 0.91 (as calculated in assumption #3, below) |
| Assumptions | 1. Food residuals constitute 13.9 percent of the US waste stream, as |
| | documented by EPA. (Source #1, below.) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #1, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Composting” and “Landfilling, |
| | National Average” columns.) The calculation for food scraps is (1 short |
| | ton × −0.2 MTCO2E/short ton) − (1 short ton × 0.69 MTCO2E/short ton) = |
| | −0.89 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #4, |
| | below. |
| Sources | 1. http://www.epa.gov/osw/nonhaz/municipal/ |
| | 2. http://www.epa.gov/climatechange/wycd/waste/measureghg.html#balance |
| | 3. http://www.epa.gov/climatechange/wycd/waste/calculators/Warm_home.html |
| | 4. http://www.epa.gov/climatechange/wycd/waste/downloads/life-cycle-ghg-accounting-versus-ghg-emission-inventories10-28-10.pdf |
| User Notes | 1. Composting helps prevent global warming by reducing emissions of |
| | methane, a powerful greenhouse gas produced when organic waste |
| | decomposes when buried in landfill sites. When waste is sent to landfill, |
| | air cannot get to the organic waste. As the waste decomposes, it forms |
| | methane, a harmful greenhouse gas, which damages the Earth's |
| | atmosphere. However, when this same waste is composted above ground |
| | at home or at a facility that composts, oxygen helps the waste to |
| | decompose aerobically. This means little or no methane is produced, |
| | reducing global warming. (See |
| | http://wiki.answers.com/Q/How_does_composting_help_global_warming). |
| | 2. For information from a reliable source on composting, including |
| | information about local composting facilities, see |
| | http://earth911.com/recycling/garden/composting/. |
| Goal 2 | Compost yard trimmings each time you work in your yard |
| Category | Waste Reduction and Recycling |
| Difficulty | 2 trees, 1 dollar sign |
| Additional | The average American generates about 4.43 pounds of waste daily, of which |
| Information | 13.4% is yard trimmings. |
| (Expanded | |
| View) | |
| User Input | Completed/Not Completed |
| Carbon | Refer to this formula to calculate pounds of waste avoided annually |
| Calculation | Pounds of waste avoided annually = 13.4% × 4.43 pounds per person per day × |
| | 365 days in a year |
| | pounds of CO2 emissions avoided annually = [Pounds of waste avoided |
| | annually] (as calculated above) × 0.04 (as calculated in assumption #3, below) |
| Assumptions | 1. Yard trimmings constitute 13.4 percent of the US waste stream, as |
| | documented by EPA. (Source #1, below.) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #1, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Composting” and “Landfilling, |
| | National Average” columns.) The calculation for yard trimmings is (1 |
| | short ton × −0.2 MTCO2E/short ton) − (1 short ton × −0.16 MTCO2E/short |
| | ton) = −0.04 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #4, |
| | below. |
| Sources | 1. http://www.epa.gov/osw/nonhaz/municipal/ |
| | 2. http://www.epa.gov/climatechange/wycd/waste/measureghg.html#balance |
| | 3. http://www.epa.gov/climatechange/wycd/waste/calculators/Warm_home.html |
| | 4. http://www.epa.gov/climatechange/wycd/waste/downloads/life-cycle-ghg-accounting-versus-ghg-emission-inventories10-28-10.pdf |
| User Notes | 1. Composting helps prevent global warming by reducing emissions of |
| | methane, a powerful greenhouse gas which gets produced when organic |
| | waste decomposes when buried in landfill sites. When waste is sent to |
| | landfill, air cannot get to the organic waste. As the waste decomposes, it |
| | forms methane, a harmful greenhouse gas, which damages the Earth's |
| | atmosphere. However, when this same waste is composted above ground |
| | at home or at a facility that composts, oxygen helps the waste to |
| | decompose aerobically. This means little or no methane is produced, |
| | reducing global warming. (See |
| | http://wiki.answers.com/Q/How_does_composting_help_global_warming). |
| | 2. For information from a reliable source on composting, including |
| | information about local composting facilities, see |
| | http://earth911.com/recycling/garden/composting/. |
| Goal 3 | Recycle aluminum cans each week |
| Category | Waste Reduction and Recycling |
| Difficulty | 1 tree |
| Additional | The average American generates about 4.43 pounds of waste daily, of which |
| Information | about 0.76% is aluminum cans. |
| (Expanded | |
| View) | |
| User Input | Completed/Not Completed |
| Carbon | Refer to this formula to calculate pounds of waste avoided annually |
| Calculation | Pounds of waste avoided annually = 0.76% × 4.43 pounds per person per day × |
| | 365 days in a year |
| | pounds of CO2 emissions avoided annually = [Pounds of waste avoided |
| | annually] (as calculated above) × 8.93 (as calculated in assumption #3, below) |
| Assumptions | 1. Aluminum cans constitute 0.76% of the US waste stream, as documented |
| | by EPA. (Source #1, below: 1.9 ÷ 249.86 = 0.76%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #2, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for aluminum cans is (1 |
| | short ton × −8.89 MTCO2E/short ton) − (1 short ton × 0.04 MTCO2E/short |
| | ton) = −8.93 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #4, |
| | below. |
| Sources | 1. http://www.epa.gov/osw/nonhaz/municipal/pubs/msw_2010_rev_factsheet.pdf -- |
| | see Table 2 on page 7 |
| | 2. http://www.epa.gov/osw/nonhaz/municipal/ |
| | 3. http://www.epa.gov/climatechange/wycd/waste/calculators/Warm_home.html |
| | 4. http://www.epa.gov/climatechange/wycd/waste/downloads/life-cycle-ghg-accounting-versus-gha-emission-inventories10-28-10.pdf |
| User Notes | For more information from a reliable source on aluminum can recycling, |
| | including information about local facilities, see |
| | http://earth911.com/recycling/metal/aluminum-can/. |
| Goal 4 | Recycle plastic bottles and containers |
| Category | Waste Reduction and Recycling |
| Difficulty | 1 tree |
| Additional | The average American generates about 4.43 pounds of waste daily, of which |
| Information | about 3.9% is plastic bottles and containers. |
| (Expanded | |
| View) | |
| User Input | Completed/Not Completed |
| Carbon | Refer to this formula to calculate pounds of waste avoided annually |
| Calculation | Pounds of waste avoided annually = 3.9% × 4.43 pounds per person per day × |
| | 365 days in a year |
| | pounds of CO2 emissions avoided annually = [Pounds of waste avoided |
| | annually] (as calculated above) × 1.02 (as calculated in assumption #3, below) |
| Assumptions | 1. Plastic bottles and containers constitute 3.9% of the US waste stream, as |
| | documented by EPA. From source #1, below, total plastic containers & |
| | packaging is 13,680 thousands of tons, of which 3,930 is bags, sacks and |
| | wraps. 13,680 − 3,930 = 9,750. 9,750 ÷ 249,860 (total municipal solid |
| | waste - see Source #2 below) = 3.9%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #3, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for plastic containers (use |
| | “Mixed Plastics”) is (1 short ton × −0.98 MTCO2E/short ton) − (1 short |
| | ton × 0.04 MTCO2E/short ton) = −1.02 MTCO2E. Note that a negative |
| | value indicates an emission reduction; a positive value indicates an |
| | emission increase. Alternatively, one may use the following online |
| | calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #5, |
| | below. |
| Sources | 1. http://www.epa.gov/osw/nonhaz/municipal/pubs/2010_MSW_Tables_and_Figures_508.pdf -- |
| | see Table 7 on page 9 of the PDF |
| | 2. http://www.epa.gov/osw/nonhaz/municipal/pubs/msw_2010_rev_factsheet.pdf -- |
| | see Table 2 on page 7 |
| | 3. http://www.epa.gov/osw/nonhaz/municipal/ |
| | 4. http://www.epa.gov/climatechange/wycd/waste/calculators/Warm_home.html |
| | 5. http://www.epa.gov/climatechange/wycd/waste/downloads/life-cycle-ghg-accounting-versus-ghg-emission-inventories10-28-10.pdf |
| User Notes | For more information from a reliable source on plastic recycling, including |
| | information about local facilities, see http://earth911.com/recycling/plastic/. |
| Goal 5 | Recycle glass containers each week |
| Category | Waste Reduction and Recycling |
| Difficulty | 1 tree |
| Additional | The average American generates about 4.43 pounds of waste daily, of which |
| Information | about 3.75% is glass containers. |
| (Expanded | |
| View) | |
| User input | Completed/Not Completed |
| Carbon | Refer to this formula to calculate pounds of waste avoided annually |
| Calculation | Pounds of waste avoided annually = 3.75% × 4.43 pounds per person per day × |
| | 365 days in a year |
| | pounds of CO2 emissions avoided annually = [Pounds of waste avoided |
| | annually] (as calculated above) × 0.32 (as calculated in assumption #3, below) |
| Assumptions | 1. Glass containers constitute 3.75% of the US waste stream, as documented |
| | by EPA. (Source #1, below: 9.36 ÷ 249.86 = 3.75%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #2, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for glass containers is (1 |
| | short ton × −0.28 MTCO2E/short ton) − (1 short ton × 0.04 MTCO2E/short |
| | ton) = −0.32 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #4, |
| | below. |
| Sources | 1. http://www.epa.gov/osw/nonhaz/municipal/pubs/msw_2010_rev_factsheet.pdf -- |
| | see Table 2 on page 7 |
| | 2. http://www.epa.gov/osw/nonhaz/municipal/ |
| | 3. http://www.epa.gov/climatechange/wycd/waste/calculators/Warm_home.html |
| | 4. http://www.epa.gov/climatechange/wycd/waste/downloads/life-cycle-ghg-accounting-versus-ghg-emission-inventories10-28-10.pdf |
| User Notes | For more information from a reliable source on glass recycling, including |
| | information about local facilities, see http://earth911.com/recycling/glass/. |
| Goal 6 | Recycle steel cans each week |
| Category | Waste Reduction and Recycling |
| Difficulty | 1 tree |
| Additional | The average American generates about 4.43 pounds of waste daily, of which |
| Information | about 1.1% is steel cans. |
| (Expanded | |
| View) | |
| User Input | Completed/Not Completed |
| Carbon | Refer to this formula to calculate pounds of waste avoided annually |
| Calculation | Pounds of waste avoided annually = 1.1% × 4.43 pounds per person per day × |
| | 365 days in a year |
| | pounds of CO2 emissions avoided annually = [Pounds of waste avoided |
| | annually] (as calculated above) × 1.84 (as calculated in assumption #3, below) |
| Assumptions | 1. Steel containers constitute 1.1% of the US waste stream, as documented |
| | by EPA. (Source #1, below: 2.74 ÷ 249.86 = 1.1%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #2, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for steel cans is (1 short ton × |
| | −1.8 MTCO2E/short ton) − (1 short ton × 0.04 MTCO2E/short ton) = −1.84 |
| | MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #4, |
| | below. |
| Sources | 1. http://www.epa.gov.osw/nonhaz/municipal/pubs/msw_2010_rev_factsheet.pdf -- |
| | see Table 2 on page 7 |
| | 2. http://www.epa.gov/osw/nonhaz/municipal/ |
| | 3. http://www.epa.gov/climatechange/wycd/waste/calculators/Warm_home.html |
| | 4. http://www.epa.gov/climatechange/wycd/waste/downloads/life-cycle-ghg-accounting-versus-ghg-emission-inventories10-28-10.pdf |
| User Notes | For more information from a reliable source on steel recycling, including |
| | information about local facilities, see |
| | http://earth911.com/recycling/metal/steel/. |
| Goal 7 | Recycle newspapers each week |
| Category | Waste Reduction and Recycling |
| Difficulty | 2 trees |
| Additional | The average American generates about 4.43 pounds of waste daily, of which |
| Information | about 3.95% is newspaper. |
| (Expanded | |
| View) | |
| User Input | Completed/Not Completed |
| Carbon | Refer to this formula to calculate pounds of waste avoided annually |
| Calculation | Pounds of waste avoided annually = 3.95% × 4.43 pounds per person per day × |
| | 365 days in a year |
| | pounds of CO2 emissions avoided annually = [Pounds of waste avoided |
| | annually] (as calculated above) × 1.77 (as calculated in assumption #3, below) |
| Assumptions | 1. Newspapers constitute 3.95% of the US waste stream, as documented by |
| | EPA. From source #1 below, newspapers/mechanical papers are 9,880 of |
| | the 33,570 thousand tons of Total Paper and Paperboard Nondurable |
| | Goods. 9,880 ÷ 33,570 = 29.43%. From source #2 below, paper and |
| | paperboard nondurable goods constitute 33.57 million tons of total |
| | municipal solid waste. 29.43% of 33.57 million tons is 9.88 million tons. |
| | Therefore, newspapers constitute 9.88 of the total 249.86 million tons of |
| | municipal solid waste in the US, about 3.95%. |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #3, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for newspaper is (1 short |
| | ton × −2.78 MTCO2E/short ton) − (1 short ton × −1.01 MTCO2E/short ton) = |
| | −1.77 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #5, |
| | below. |
| Sources | 1. http://www.epa.gov/osw/nonhaz/municipal/pubs/2010_MSW_Tables_and_Figures_508.pdf -- |
| | see Table 4 on page 5 of the PDF |
| | 2. http://www.epa_gov/osw/nonhaz/municipal/pubs/msw_2010_rev_factsheet.pdf -- |
| | see Table 2 on page 7 |
| | 3. http://www.epa.gov/osw/nonhaz/municipal/ |
| | 4. http://www.epa.gov/climatechange/wycd/waste/calculators/Warm_home.html |
| | 5. http://www.epa.gov/climatechange/wycd/waste/downloads/life-cycle-ghg-accounting-versus-ghg-emission-inventories10-28-10.pdf |
| User Notes | For more information from a reliable source on newspaper recycling, |
| | including information about local facilities, see |
| | http://earth911.com/recycling/paper/newspaper/. |
| Goal 8 | Recycle magazines and mail order catalogues |
| Category | Waste Reduction and Recycling |
| Difficulty | 2 trees |
| Additional | The average American generates about 4.43 pounds of waste daily, of which |
| Information | about 0.64% is magazines. |
| (Expanded | |
| View) | |
| User Input | Completed/Not Completed |
| Carbon | Refer to this formula to calculate pounds of waste avoided annually |
| Calculation | Pounds of waste avoided annually = 0.64% × 4.43 pounds per person per day × |
| | 365 days in a year |
| | pounds of CO2 emissions avoided annually = [Pounds of waste avoided |
| | annually] (as calculated above) × 2.6 (as calculated in assumption #3, below) |
| Assumptions | 1. Magazines constitute 0.64% of the US waste stream, as documented by |
| | EPA. From source #1 below, magazines are 1,590 of the 33,570 thousand |
| | tons of Total Paper and Paperboard Nondurable Goods. 1,590 ÷ 33,570 = |
| | 4.74%. From source #2 below, paper and paperboard nondurable goods |
| | constitute 33.57 million tons of total municipal solid waste. 4.74% of |
| | 33.57 million tons is 1.59 million tons. Therefore, magazines constitute |
| | 1.59 of the total 249.86 million tons of municipal solid waste in the US, |
| | about 0.64%. |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #3, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for magazines is (1 short |
| | ton × −3.07 MTCO2E/short ton) − (1 short ton × −0.47 MTCO2E/short ton) = |
| | −2.6 MTCO2E. Note that a negative value indicates an emission |
| | reduction; a positive value indicates an emission increase. Alternatively, |
| | one may use the following online calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #5, |
| | below. |
| Sources | 1. http://www.epa.gov/osw/nonhaz/municipal/pubs/2010_MSW_Tables_and_Figures_508.pdf -- |
| | see Table 4 on page 5 of the PDF |
| | 2. http://www.epa.gov/osw/nonhaz/municipal/pubs/msw_2010_rev_factsheet.pdf -- |
| | see Table 2 on page 7 |
| | 3. http://www.epa.gov/osw/nonhaz/municipal/ |
| | 4. http://www.epa.gov/climatechange/wycd/waste/calculaors/Warm_home.html |
| | 5. http://www.epa.gov/climatechange/wycd/waste/downloads/life-cycle-ghg-accounting-versus-ghg-emission-inventories10-28-10.pdf |
| User Notes | For more information from a reliable source on magazine recycling, including |
| | information about local facilities, see |
| | http://earth911.com/recycling/paper/magazines/. |
| Goal 9 | Recycle plastic bags, sacks, and film packaging |
| | (e.g., trash bags, retail bags, dry cleaning bags, produce bags, trash can liners, |
| | bread bags, and frozen food bags) |
| Category | Waste Reduction and Recycling |
| Difficulty | 1 tree |
| Additional | The average American generates about 4.43 pounds of waste daily, of which |
| Information | about 1.57% is plastic bags and film packaging. |
| (Expanded | |
| View) | |
| User Input | Completed/Not Completed |
| Carbon | Refer to this formula to calculate pounds of waste avoided annually |
| Calculation | Pounds of waste avoided annually = 1.57% × 4.43 pounds per person per day] × |
| | 365 days in a year |
| | pounds of CO2 emissions avoided annually = [Pounds of waste avoided |
| | annually] (as calculated above) × 1.26 (as calculated in assumption #3, below) |
| Assumptions | 1. Plastic bags and film packaging constitute 1.57% of the US waste stream, |
| | as documented by EPA. From source #1, below, total plastic bags and |
| | film packaging is 3,930 thousands of tons. 3,930 ÷ 249,860 (total |
| | municipal solid waste - see Source #2 below) = 1.57%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #3, below.) |
| | 3. Emission factors are available in units of metric tons of carbon dioxide |
| | equivalent (MTCO2E) at |
| | http://www.epa.gov/climatechange/wycd/waste/calculators/Warm_home/html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for HDPE (no data on |
| | LDPE recycling is available) is (1 short ton × −0.86 MTCO2E/short ton) − |
| | (1 short ton × 0.04 MTCO2E/short ton) = −1.26 MTCO2E. Note that a |
| | negative value indicates an emission reduction; a positive value indicates |
| | an emission increase. Alternatively, one may use the following online |
| | calculator to produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #5, |
| | below. |
| Sources | 1. http://www.epa.gov/osw/nonhaz/municipal/pubs/2010_MSW_Tables_and_Figures_508.pdf -- |
| | see Table 7 on page 9 of the PDF |
| | 2. http://www.epa.gov/osw/nonhaz/municipal/pubs/msw_2010_rev_factsheet.pdf -- |
| | see Table 2 on page 7 |
| | 3. http://www.epa.gov/osw/nonhaz/municipal/ |
| | 4. http://www.epa.gov/climatechange/wycd/waste/calculators/Warm_home.html |
| | 5. http://www.epa.gov/climatechange/wycd/waste/downloads/life-cycle-ghg-accounting-versus-ghg-emission-inventories10-28-10.pdf |
| User Notes | 1. On the majority of packaging in the U.S., one will find a chasing arrow |
| | symbol with a number inside. This is a resin identification code (RIC) and |
| | it represents the type of resin used in a package. Plastic bags and film |
| | packaging are generally #2 and #4 plastic, both of which are recyclable. |
| | Trash and retail bags are generally #2, HDPE (or High-density |
| | polyethylene). Dry cleaning bags produce bags, trash can liners, bread |
| | bags, frozen food bags are generally #4 LDPE (or Low-density |
| | polyethylene). |
| | 2. Many retailers, including WalMart, Lowes, Target, and a number of |
| | grocery store chains accept plastic bags, film and wraps for recycling. |
| | Next time add “recycling plastic bags and film” to your shopping list so |
| | you don't forget to recycle while you're shopping! |
| | 3. For more information from a reliable source on plastic bag recycling, |
| | including information about local facilities, see |
| | http://earth911.com/recycling/plastic/plastic-bags/. |
| Goal 10 | Recycle corrugated cardboard boxes |
| Category | Waste Reduction and Recycling |
| Difficulty | 3 trees |
| Additional | The average American generates about 4.43 pounds of waste daily, of which |
| Information | about 11.6% is cardboard boxes. |
| (Expanded | |
| View) | |
| User Input | Completed/Not Completed |
| Carbon | Refer to this formula to calculate pounds of waste avoided annually |
| Calculation | Pounds of waste avoided annually = 11.6% × 4.43 pounds per person per day × |
| | 365 days in a year |
| | pounds of CO2 emissions avoided annually = [Pounds of waste avoided |
| | annually] (as calculated above) × 3.06 (as calculated in assumption #3, below) |
| Assumptions | 1. Corrugated cardboard boxes constitute 11.6% of the US waste stream, as |
| | documented by EPA. From source #1, below, Americans generated |
| | 29,050 thousands of tons of corrugated boxes in 2010. 29,050 ÷ 249,860 |
| | (total municipal solid waste - see Source #2 below) = 11.6%) |
| | 2. In 2010, Americans generated about 250 million tons of trash and |
| | recycled and composted over 85 million tons of this material, equivalent |
| | to a 34.1 percent recycling rate. On average, we recycled and composted |
| | 1.51 pounds of individual waste generation of 4.43 pounds per person per |
| | day. (Source #3, below.) |
| | 3. Emission factors are available in units of metric tons of carbon dioxide |
| | equivalent (MTCO2E) at |
| | http://www.epa.gov/climatechange/wycd/waste/calculators/Warm_home.html. |
| | (Click on the hyperlink, metric tons of carbon dioxide equivalent |
| | (MTCO2E) in paragraph 4. From the “WARM Emission Factors” table |
| | that opens up, use the numbers in the “Recycling” and “Landfilling, |
| | National Average” columns.) The calculation for cardboard (“corrugated |
| | containers”) is (1 short ton × −3.11 MTCO2E/short ton) − (1 short ton × −0.05 |
| | MTCO2E/short ton) = −3.06 MTCO2E. Note that a negative value |
| | indicates an emission reduction; a positive value indicates an emission |
| | increase. Alternatively, one may use the following online calculator to |
| | produce the same result: |
| | http://www.epa.gov/climatechange/wycd/waste/calculators/Warm_Form.html. |
| | Note that results here appear to be rounded to the nearest integer, |
| | which may account for the slight difference from the calculation above. |
| | 4. This approach is based on a life-cycle approach, which reflects emissions |
| | and avoided emissions upstream and downstream from the point of use. |
| | As such, these calculations provide an account of the net benefit of |
| | recycling to the environment. For additional details, see Source #5, |
| | below. |
| Sources | 1. http://www.epa.gov/osw/nonhaz/municipal/pubs/2010_MSW_Tables_and_Figures_508.pdf -- |
| | see Table 4 on page 5 of the PDF |
| | 2. http://www.epa.gov/osw/nonhaz/municipal/pubs/msw_2010_rev_factsheet.pdf -- |
| | see Table 2 on page 7 |
| | 3. http://www.epa.gov/osw/nonhaz/municipal/ |
| | 4. http://www.epa.gov/climatechange/wycd/waste/calculators/Warm_home.html |
| | 5. http://www.epa.gov/climatechange/wycd/waste/downloads/life-cycle-ghg-accounting-versus-ghg-emission-inventories10-28-10.pdf |
| Notes | For more information from a reliable source on cardboard recycling, |
| | including information about local facilities, see |
| | http://earth911.com/recycling/paper/cardboard/. |

Exemplary Water Impact Reduction Goals:

| Goal 1 | Turn off the water while brushing your teeth |
|---|---|
| Category | Water |
| Difficulty | 1 Dollar |
| Additional | Saves 8 gallons of water per day, or 2,920 gallons of water annually |
| Information | |
| (Expanded | |
| View) | |
| User Input | Completed/Not Completed |
| Carbon | n/a |
| Calculation | |
| Assumptions | 1. People brush their teeth an average of two times a day, and the faucet runs |
| | for two minutes per brushing. |
| | 2. According to the new EPA WaterSense initiative, the average bathroom |
| | sink faucet flows at a rate of two gallons a minute. |
| Sources | 1. http://www.thedailygreen.com/going-green/tips/tap-water-conservation-tip |
| | 2. http://www.epa.gov/WaterSense/pubs/indoor.html |
| User Notes | |
| Goal 2 | Turn off the water while shaving |
| Category | Water |
| Difficulty | 1 Dollar |
| Additional | Saves 4 gallons of water per day, or 1,460 gallons of water annually |
| Information | |
| (Expanded | |
| View) | |
| User Input | Completed/Not Completed |
| Carbon | n/a |
| Calculation | |
| Assumptions | 1. Average person shaves once a day, and the faucet (or shower) runs for |
| | two minutes per shaving. |
| | 2. According to the new EPA WaterSense initiative, the average bathroom |
| | sink faucet flows at a rate of two gallons a minute. |
| Sources | 1. http://www.thedailygreen.com/going-green/tips/tap-water-conservation-tip |
| | 2. http://www.epa.gov/WaterSense/pubs/indoor.html |
| User Notes | |
| Goal 3 | Use a refillable water bottle instead of bottled drinking water |
| Category | Water |
| Difficulty | 2 Dollars |
| Additional | Saves 84 gallons of water annually. |
| Information | |
| (Expanded | |
| View) | |
| User Input | Completed/Not Completed |
| Carbon | N/A |
| Calculation | |
| Assumptions | 1. The average person consumes some 28 gallons of bottled water each year, |
| | according to EDF (see link #1 below.) |
| | 2. In addition to the water sold in plastic bottles, the Pacific Institute |
| | estimates that twice as much water is used in the production process. |
| | Thus, every gallon sold represents three gallons of water. |
| Sources | 1. http://business.edf.org/food-water/restaurants-and-dining/sustainable- |
| | food-purchasing-bottled-beverages |
| | 2. http://www.pacinst.org/topics/water_and_sustainability/bottled_water/bottled_water_and_energy.html |
| | http://www.realsimple.com/home-organizing/green-living/things-save-water-10000001717653/index.html |
| User Notes | 1. Additional reasons to stop using bottled water are available here: |
| | http://green.yourway.net/5-reasons-to-ditch-disposable-water-bottles/. |
| | 2. We have estimated the carbon savings from recycling plastic bottles and |
| | containers in the document “Waste reduction and recycling goals.docx”. |
| Goal 4 | Fix a leaky toilet |
| Category | Water |
| Difficulty | 3 dollars |
| Additional | Fixing a leaky toilet can save about 200 gallons of water daily. |
| Information | |
| (Expanded | |
| View) | |
| User Input | Completed/Not Completed |
| Savings | Gallons of water saved annually = 365 × 200 |
| Calculation | |
| Carbon | N/A |
| Calculation | |
| Assumptions | According to EPA's WaterSense program, a leaky toilet can waste about 200 |
| | gallons of water every day. See source below. |
| Sources | http://www.epa.gov/WaterSense/pubs/indoor.html |
| User Notes | To check your toilet for a leak, place a few drops of food coloring in the tank |
| | and wait. If the color appears in the bowl, then there's a leak. Often these |
| | leaks can be fixed with a few minor adjustments, cleaning calcium deposits |
| | from the toilet ball in the tank, or by replacing worn valves. |
| Goal 5 | Fix a leaky sink |
| Category | Water |
| Difficulty | 2 Dollars |
| Additional | A leak of one gallon every 24 minutes-not considered a big leak-totals 2.5 |
| Information | gallons per hour or 60 gallons per day |
| (Expanded | |
| View) | |
| User Input | Completed/Not Completed |
| Savings | Gallons of water saved annually = 365 × 60 |
| Calculation | |
| Carbon | N/A |
| Calculation | |
| Assumptions | According to The Groundwater Foundation, a leak of one gallon every 24 |
| | minutes-an average amount-totals 2.5 gallons per hour or 60 gallons per |
| | day. See source below. |
| Sources | http://www.groundwater.org/kc/easywaystoconserve.html |
| User Notes | You can turn off the drip by replacing worn washers or valve seats. |
| Goal 6 | Scrape, don't rinse dishes when loading the dishwasher |
| Category | Water |
| Difficulty | 1 dollar |
| Additional | Not rinsing dishes prior to loading the dishwasher could save up to 10 gallons |
| Information | per load. |
| (Expanded | |
| View) | |
| User Input | Approximate # of dishwasher loads per week |
| Savings | Gallons of water saved annually = [Approximate # of dishwasher loads per |
| Calculation | week] × 52 × 10 |
| Carbon | N/A |
| Calculation | |
| Assumptions | Not rinsing dishes before loading dishwasher could save up to 10 gallons of |
| | water per load |
| Sources | http://www.epa.gov/WaterSense/pubs/indoor.html |
| User Notes | Depending on your dishwasher's effectiveness, this may not be entirely |
| | practical for very sticky foods, such as egg yolk. |
| Goal 7 | Change your showerhead to a low-flow showerhead |
| Category | Water, Energy |
| Difficulty | 2 Dollars |
| Additional | By switching to a low-flow showerhead, you could save up to 10 gallons of |
| Information | water per 10-minute shower (or, a gallon per minute) |
| (Expanded | |
| View) | |
| User Input | Avg. length of shower, in minutes; number of showers per day |
| Savings | Gallons of water saved annually = [Ave. length of shower in minutes] × |
| Calculation | [number of showers per day] × 365 |
| Carbon | N/A |
| Calculation | |
| Assumptions | Water savings is based on the difference between a base model showerhead |
| | (2.5 gallons per minute) and a low-flow model (1.5 gallons per minute). It is |
| | possible that older showerheads use much more water than even the base |
| | model. |
| Sources | 1. http://www.fypower.org/res/tools/products_results.html?id=100160 |
| | 2. http://www.epa.gov/watersense/products/showerheads.html |
| User Notes | A low-flow showerhead will also save gas or electricity associated with |
| | heating water |
| Goal 8 | Install low-flow faucets or aerators on your faucets |
| Category | Water |
| Difficulty | 2 dollars |
| Savings | By installing low-flow faucets or aerators that restrict water flow, the average |
| | household can save more than 500 gallons a year. |
| User Input | Completed/Not Completed |
| Savings | N/A |
| Calculation | |
| Carbon | N/A |
| Calculation | |
| Assumptions | 1. According to EPA's WaterSense program, by installing low-flow |
| | bathroom sink faucets or faucet aerators, an average household can save |
| | more than 500 gallons each year. The WaterSense specification for |
| | lavatory faucets is 1.5 gallons per minute (gpm). |
| | 2. Retrofit studies conducted in Seattle, Washington, and East Bay |
| | Municipal Utility District in California have shown that a household can |
| | save approximately 570 gallons per year by simply replacing existing |
| | bathroom sink faucet aerators with high-efficiency 1.5 gpm aerators. |
| Sources | 1. http://epa.gov/watersense/products/bathroom_sink_faucets.html |
| | 2. http://www.epa.gov/WaterSense/pubs/faq_bs.html |
| | 3. http://www.realsimple.com/home-organizing/green-living/things-save- |
| | water- |
| | 10000001717653/index.htmlhttp://eartheasy.com/live_lowflow_aerators.htm |
| User Notes | 1. Typically new kitchen faucets will be equipped with a 2.2 gallons per |
| | minute (gpm) aerator, while bathroom faucets usually have aerators that |
| | restrict flow to 1.5, 1.2, or even 1.0 gpm. If an aerator is already installed |
| | on the faucet, it will have its rated flow imprinted on the side. This should |
| | read 2.75 gpm or lower. If the flow rate is higher, then it should be |
| | replaced. If no aerator is installed, check to see if there are threads just |
| | inside the tip of the faucet. Most modern faucets are threaded to accept |
| | aerators. For highest efficiency, insist on 1.0 gpm flow restrictors. It is the |
| | aerator (the screw-on tip of the faucet nozzle) that ultimately determines |
| | the maximum flow rate for water. It's a good idea to bring your old aerator |
| | (and any associated washers) to the store when you purchase a new one to |
| | ensure that the new aerator will fit on the faucet fixture. Low-flow faucet |
| | aerators usually cost $5-$10 or less. |
| | 2. A low-flow faucet or aerator will also save gas or electricity associated |
| | with heating water |
| Goal 9 | Buy a front-loading clothes washing machine |
| Category | Energy and Water |
| Difficulty | 3 dollars |
| Savings | Front loaders use 40-75% less water and 30-85% less energy than typical top- |
| | loaders. Front-loaders cost about $100 more than top-loaders, but common |
| | savings are $100/yr. |
| User Input | Completed/Not Completed |
| Savings | $ saved annually = roughly $100. |
| Calculation | Gallons of water saved annually = [40 gallons per load for a top loader] − [15 |
| | gallons per load for a front loader] × [392 loads per year] = 9800 |
| Assumptions | 4. $100 annual savings includes energy + water + water heating costs. (See |
| | “Front-loading washing machines are the way to go” at the first link |
| | below.) |
| | 5. kWh savings annually = energy savings of front-loader vs. top-loader (30-85%). |
| | That's 120-560 kWh/yr vs. 800 kWh/yr. The midpoint of 120-560 |
| | is 340 kWh, so the savings is 800-340 or 460 kWh. Sources: |
| | http://michaelbluejay.com/electricity/laundry.html and |
| | http://michaelbluejay.com/electricity/laundry-sources.html. |
| | 6. Loads per year = 392 (or about 7.5 per week). Source: US EPA |
| | ENERGY STAR Program. See |
| | http://www.energystar.gov/index.cfm?fuseaction=clotheswash.display_column_definitions. |
| | 7. kWh savings can be converted into lbs of CO² avoided with this formula: |
| | [savings in kWh] × 1.52. (Source for conversion factor: |
| | http://www.epa.gov/greenpower/pubs/calcmeth.htm: 6.8956 × 10⁻⁴ metric |
| | tons CO₂/kWh × 2204.62262 lbs/metric ton = 1.52) |
| Sources | 3. http://michaelbluejay.com/electricity/laundry.html |
| | 4. http://michaelbluejay.com/electricity/laundry-sources.html |
| | 5. http://www.energystar.gov/index.cfm?fuseaction=clotheswash.display_column_definitions. |
| User Notes | 1. The only time a front-loader won't pay for itself is if you already use cold |
| | water almost exclusively, and you do a lot less than the average 7.5 loads |
| | per week. |
| | 2. It is possible to do a detailed calculation of savings based on washer type, |
| | temperature of washes, utility rates, # of loads per week, and more. (See |
| | “Laundry Costs Calculator” at |
| | http://michaelbluejay.com/electricity/laundry.html.) |
| Goal 10 | Replace old toilets with newer, more-efficient models |
| Category | Water |
| Difficulty | 2 dollars |
| Savings | 4875 gallons of water per year, per person (average of 3500 and 6250) |
| User Input | [# people in household] |
| Savings | [# people in household] × 4875 = minimum # gallons saved annually |
| Calculation | |
| Carbon | N/A |
| Calculation | |
| Assumptions | Toilets are older than 1992 |
| Sources | http://www.energystar.gov/index.cfm?c=products.pr_protect_water_supplies |
| User Notes | If your home was built before 1992 and you haven't replaced your toilets |
| | recently, installing high efficiency toilets that use 1.6 gallons or less per flush |
| | could save a family of four 14,000 to 25,000 gallons of water per year. |

1. An environmental impact analysis system for analyzing the environmental impact of one or more system users, the system comprising:
one or more memory storage areas; and
one or more processors;
wherein the one or more processors are configured to:
display via a user interface a plurality of user consumption inquiries soliciting user input relating to user consumption of one or more resources;
receive via the user interface user input comprising user consumption data responsive to one or more of the user consumption inquiries;
calculate, based on the user consumption data, one or more user impact values indicative of the environmental footprint resulting from the user consumption of the one or more resources;
display via the user interface one or more of the calculated user impact values;
display via the user interface one or more impact reduction goals representing potential user actions that would result in a lesser environmental footprint;
receive via the user interface user input comprising goal completion data indicating user completion of one or more of the impact reduction goals; and
calculate, based on the user impact values and the goal completion data, one or more revised user impact values indicative of the user's reduced environmental footprint due to completed impact reduction goals.

2. The environmental impact analysis system of claim 1, wherein the user consumption inquiries comprise one or more transportation consumption inquiries soliciting user input relating to user consumption of fuel;
wherein the user consumption data is indicative of an amount of fuel used in relation to transportation activities; and
wherein the user impact values comprise an amount of carbon dioxide emissions generated due to the user's consumption of fuel.

3. The environmental impact analysis system of claim 1, wherein the user consumption inquiries comprise one or more home energy consumption inquiries soliciting user input relating to user consumption of home energy;
wherein the user consumption data is indicative of an amount of electrical power used in relation to home activities; and
wherein the user impact values comprise an amount of carbon dioxide emissions generated due to the user's consumption of home energy.

4. The environmental impact analysis system of claim 1, wherein the user consumption inquiries comprise one or more recycling consumption inquiries soliciting user input relating to user recycling of waste;
wherein the user consumption data is indicative of an amount of waste recycled; and
wherein the user impact values comprise an amount of carbon dioxide emissions avoided due to the users's recycling of the waste.

5. The environmental impact analysis system of claim 1, wherein the user consumption inquiries comprise one or more water consumption inquiries soliciting user input relating to user consumption of water;
wherein the user consumption data is indicative of an amount of water consumed by the user in relation to various activities; and
wherein the user impact values comprise a total amount of water used by the user.

6. The environmental impact analysis system of claim 1, wherein the one or more processors are further to configured to:
receive user input indicating that a user is a member of a user group; and
aggregate user impact values for all users in the user group; and
calculate one or more group impact values indicative of the environmental footprint resulting from the consumption of one or more resources by users in the group.

7. The environmental impact analysis system of claim 6, wherein the user group is a household.

8. The environmental impact analysis system of claim 6, wherein the user group is an employee work unit.

9. The environmental impact analysis system of claim 1, wherein the one or more impact reduction goals comprise user actions resulting in the reduction of fuel consumed in relation to transportation activities.

10. The environmental impact analysis system of claim 1, wherein the one or more impact reduction goals comprise user actions resulting in the reduction of power consumed in relation to home energy usage.

11. The environmental impact analysis system of claim 1, wherein the one or more impact reduction goals comprise user actions resulting in the reduction of water consumed.

12. The environmental impact analysis system of claim 1, wherein the one or more impact reduction goals comprise user actions resulting in an increase in an amount of waste recycled.

13. The environmental impact analysis system of claim 1, wherein the one or more processors are further configured to, in response to a first user request, generate an electronic message to a second user, the electronic message indicating a challenge to complete one or more of the impact reduction goals.

14. A non-transitory computer readable medium comprising computer executable instructions for:
displaying via a user interface a plurality of user consumption inquiries soliciting user input relating to user consumption of one or more resources;
receiving via the user interface user input comprising user consumption data responsive to one or more of the user consumption inquiries;
calculating, based on the user consumption data, one or more user impact values indicative of the environmental footprint resulting from the user consumption of the one or more resources;
displaying via the user interface one or more of the calculated user impact values;
displaying via the user interface one or more impact reduction goals representing potential user actions that would result in a lesser environmental footprint;
receiving via the user interface user input comprising goal completion data indicating user completion of one or more of the impact reduction goals; and
calculating, based on the user impact values and the goal completion data, one or more revised user impact values indicative of the user's reduced environmental footprint due to completed impact reduction goals.
